(19) United States
(12) Patent Application Publication
(10) Pub. No.: US 2012/0069238 A1
(43) Pub. Date: Mar. 22, 2012

(54) IMAGE CAPTURING DEVICE

(75) Inventors: Yuuji TOYOMURA, Fukuoka (JP); Seiji URANO, Fukuoka (JP)

(73) Assignee: PANASONIC CORPORATION, Osaka (JP)

(21) Appl. No.: 13/232,389

(22) Filed: Sep. 14, 2011

(30) Foreign Application Priority Data
Sep. 16, 2010 (JP) 2010-208092
Sep. 29, 2010 (JP) 2010-219214

(51) Int. Cl. H04N 5/225

(52) U.S. Cl. 348/340; 348/E05.024

(57) ABSTRACT

A rotation body having an optical member is stored in an optical capsule that is filled with a liquid that is an anti-freeze solution. A magnetic rotation driver rotates the rotation body by applying a magnetic force in a rotation direction to a first magnetizer provided to the rotation body, and heats the liquid. Specifically, the stator core that configures the magnetic rotation driver is formed so that a surface opposing the first magnetizer fits along a curved surface of an outer surface of the optical capsule. The opposing surface is applied with a silicon grease and then firmly attached to the optical capsule. Thus, the entire opposing surface of the stator core acts as a thermal conduction path to more efficiently heat the liquid, thereby making it possible to stably rotate the rotation body even in a cold environment.

### CROSS-REFERENCE TO RELATED APPLICATIONS

The present application claims priority under 35 U.S.C. §119 of Japanese Applications No. 2010-208092, filed on Sep. 16, 2010, and No. 2010-219214, filed on Sep. 29, 2010, the disclosures of which are expressly incorporated by reference herein in their entireties.

### BACKGROUND OF THE INVENTION

1. Field of the Invention

The present invention relates to an image capturing device that obtains a plurality of images by performing image capturing while slightly displacing optical images formed on a light-receiving surface of an image capturing element relative to the image capturing element.

2. Description of Related Art

An image capturing device employs an image capturing element in which pixels are arranged in a two-dimensional matrix pattern. The resolution of the image capturing element is limited because it depends on the size of pixels and the number of pixels in the image capturing element. To generate images having a higher resolution than that of the image capturing element itself, super-resolution processing is performed after so-called pixel offset (optical shift), in which a plurality of original images are captured, while optical images formed on a light-receiving surface of the image capturing element are slightly displaced relative to the image capturing element.

Such a technology of pixel offset requires an optical shift mechanism for slightly displacing the optical images and the image capturing elements with respect to each other (see Related Art 1).

For example, a parallel plate is provided between the image capturing element and a lens unit that forms images on the image capturing element based on light from an object. The parallel plate is inclined with respect to the optical axis of the lens unit, and the position of the optical image on a light-receiving surface of the image capturing element is displaced by rotating the parallel plate around the optical axis (see Related Art 2 and Related Art 3).

A monitoring camera system, for example, uses a pixel offset to obtain a high-resolution image, because the pixel offset is capable of generating a high-resolution image from a stored low-resolution image when the high-resolution image is necessary for the purpose of traffic accident investigation and the like.

In a case of using an image capturing device as a monitoring camera, long-term dependability (long life-span) such as consecutive ten-year stable operation is required. It is also desired that the image capturing device produces low noise so that the device may be used in a quiet environment. However, with the conventional technology disclosed in the Related Arts 2 and 3, the parallel plate is rotationally driven by transmitting a driving force of a motor to the parallel plate through a gear mechanism, therefore it is neither possible to secure sufficient dependability nor to reduce noise.

In order to realize a long-term dependability along with less vibration and thus less noise, consideration may be given to employing a bearingless motor technology that eliminates a mechanical bearing by combining a function of a magnetic bearing with a brushless motor. When this technology is directly applied to the image capturing device that displaces an optical image by rotating a parallel plate around an optical axis, however, a relative position between an image capturing element and a rotation body, namely a parallel plate, that rotates in a magnetically levitated state, is easily shifted. Thus, it is difficult to ensure a repeatability and reproducibility of an optical shift amount (shift position). In a “positioning” process, which is a part of a super-resolution processing, a calculation cost can be greatly reduced when the optical shift position is known. When it is not known, however, a circumstance arises where a large amount of calculation cost is incurred by a repetitive processing.

Thus, a configuration is considered, in which a parallel plate along with a liquid is stored in a capsule so that the parallel plate magnetically floats in the liquid in order to produce a stable amount of the optical shift. In a case of using water as a liquid, the water possibly freezes and damages the capsule when a surrounding temperature drops below the freezing point. Therefore, it is preferable that an anti-freeze solution be used to prevent freezing when used in a cold environment. In general, however, an anti-freeze solution tends to increase its viscosity in a low temperature. Therefore, it requires a large amount of electricity to rotate a rotation body when the viscosity of the anti-freeze solution is increased when used in a cold environment. In a case where the viscosity of the anti-freeze solution becomes extremely high, it is difficult to rotate the rotation body with a desired rotation speed.

Related Art 1: Japanese Patent Laid-open Application Publication No. 2008-306492

Related Art 2: Japanese Patent Laid-open Application Publication No. 2000-125170

Related Art 3: Japanese Patent Laid-open Application Publication No. 2000-278614

### SUMMARY OF THE INVENTION

In view of the above circumstances, a main object of the present invention is to provide an image capturing device which is capable of stably rotating a rotation body even in a cold environment.

The image capturing device of the present invention includes an image capturing element that performs photoelectric conversion on light from an object and outputs a pixel signal; a lens unit that forms an image on the image capturing element based on light from the object; a capsule member in which a liquid is contained; a rotation body that is received in the capsule member and is inclined at a predetermined angle with respect to an optical axis of the lens unit; and a rotational driving device that displaces an optical image formed on a light-receiving surface of the image capturing element and the image capturing element relative to each other by rotating the rotation body about the optical axis of the lens unit. A heater is provided to the capsule member to heat the liquid.

In the present invention, the liquid can be heated by the heater via the capsule member. Therefore, it is possible to prevent the liquid from increasing its viscosity even in a low temperature, thereby making it possible to stably rotate the rotation body.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 illustrates an overall configuration of a network camera system according to the present invention;

FIG. 2 is a block diagram illustrating a schematic configuration of an image capturing device and an image processing device shown in FIG. 1;

FIG. 3 is a schematic diagram illustrating processing statuses in the image capturing device and the image processing device shown in FIG. 1;

FIG. 4 is a longitudinal cross-sectional view showing an image capturing portion of the image capturing device shown in FIG. 1;

FIG. 5 is an exploded perspective view of the image capturing portion shown in FIG. 4;

FIG. 6 is a plan view of an optical shift mechanism shown in FIG. 4;

FIG. 7 is a plan view showing one example of utilizing a conventional configuration of a three-phase motor, which is used as a base of the rotational driving device shown in FIG. 6;

FIG. 8 illustrates a configuration of a shift controller shown in FIG. 2;

FIG. 9 illustrates main portions of the rotational driving device shown in FIG. 4 and the shift controller;

FIGS. 10A and 10B are cross-sectional views showing incidence statuses of light toward the image capturing element shown in FIG. 4;

FIGS. 11A and 11B are schematic diagrams illustrating statuses of circular motions of pixels relative to an optical image;

FIGS. 12A, 12B, and 12C are schematic diagrams illustrating statuses of circular motions of pixels relative to an optical image;

FIG. 13 is a schematic diagram illustrating a status of an image capturing and images generated from the image capturing;

FIGS. 14A, 14B, and 14C are schematic diagrams illustrating statuses of image capturing reference positions in one example of a ratio of an image capturing period to a circular motion period;

FIG. 15 is an exploded perspective view showing details of an image capturing portion according to a second embodiment of the present invention;

FIG. 16A and 16B are respectively a detailed plan view and a detailed cross-sectional view of a rotation body according to the second embodiment of the present invention;

FIG. 17 is a schematic diagram illustrating a posterior posture-change status of the image capturing portion according to the second embodiment of the present invention;

FIG. 18 is a flow chart illustrating processing steps of a rotational driving control by a calculation processor according to the second embodiment of the present invention;

FIG. 19 is a schematic plan view of a rotation body according to a third embodiment of the present invention;

FIG. 20A and 20B are respectively a detailed plan view and a detailed cross-sectional view of a rotation body according to a fourth embodiment of the present invention;

FIG. 21 is a longitudinal cross-sectional view schematically showing main portions of an image capturing portion according to a fifth embodiment of the present invention; and

FIG. 22 is a longitudinal cross-sectional view schematically showing a posterior posture-change status of the image capturing portion shown in FIG. 21.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the forms of the present invention may be embodied in practice.

### First Embodiment

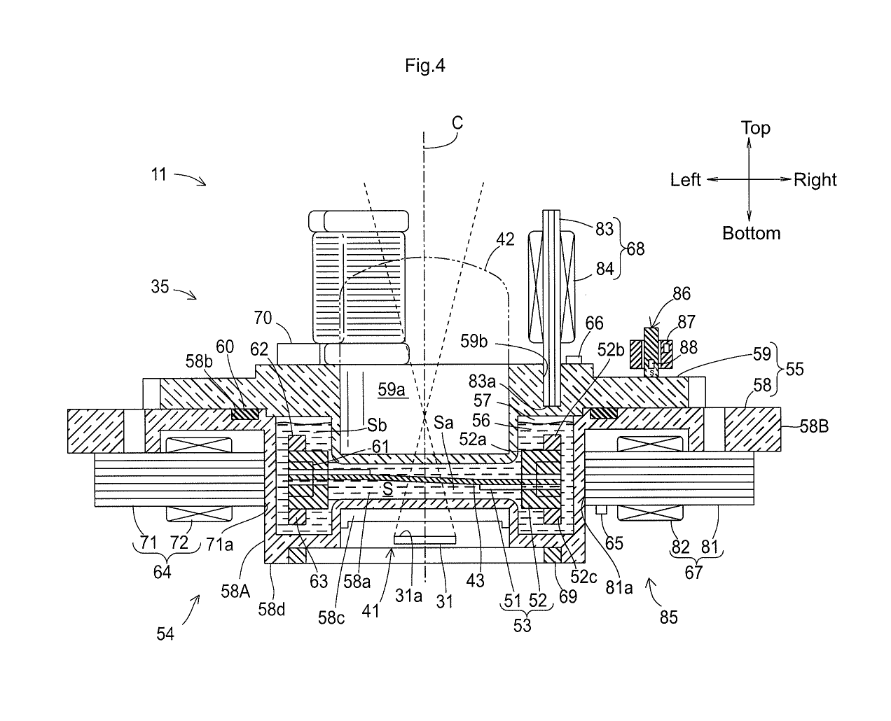

Hereinafter, a first embodiment of the present invention will be described with reference to the accompanying drawings. In the following description, the “axial” direction refers to the direction of the optical axis (corresponding to the top-bottom direction in FIG. 4), and the “radial” direction refers to the direction perpendicular to the optical axis (corresponding to the left-right direction in FIG. 4). The radial direction can be any angle within 360 degrees around the optical axis.

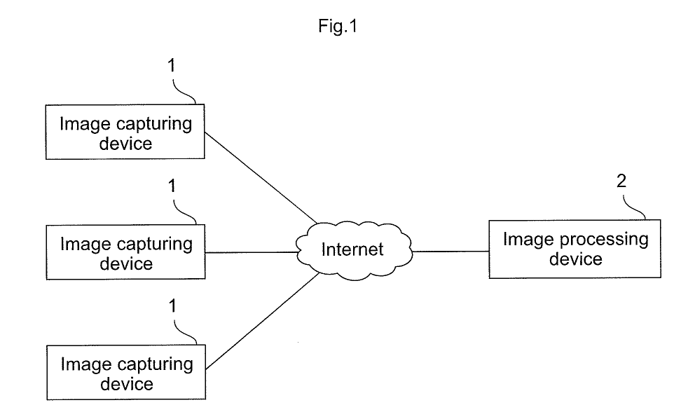

FIG. 1 illustrates an overall configuration of a network camera system according to the present invention. As shown in FIG. 1, the network camera system to which the present invention is applied includes at least one image capturing device (network camera) 1, and an image processing device (host device) 2. The image capturing device 1 and the image processing device 2 are connected through the Internet, and a captured image data generated by the image capturing device 1 is transmitted to the image processing device 2 located, for example, in a remote place so as to display the screen image on the image processing device 2. Various kinds of command signals that control the image capturing device 1 are transmitted from the image processing device 2 to the image capturing device 1.

The captured image data is transmitted from the image capturing device 1 to the image processing device 2 by use of the Internet Protocol such as TCP (UDP)/IP. However, it may be transmitted by use of VPN (Virtual Private Network), for example, after encryption or encapsulation. It is also possible to use a network camera system called as CCTV (Closed Circuit TV) in which the image capturing device 1 and the image processing device 2 are connected one-on-one by a private line. However, these are merely examples, and other image capturing elements can also be utilized without departing from the scope of the present invention.

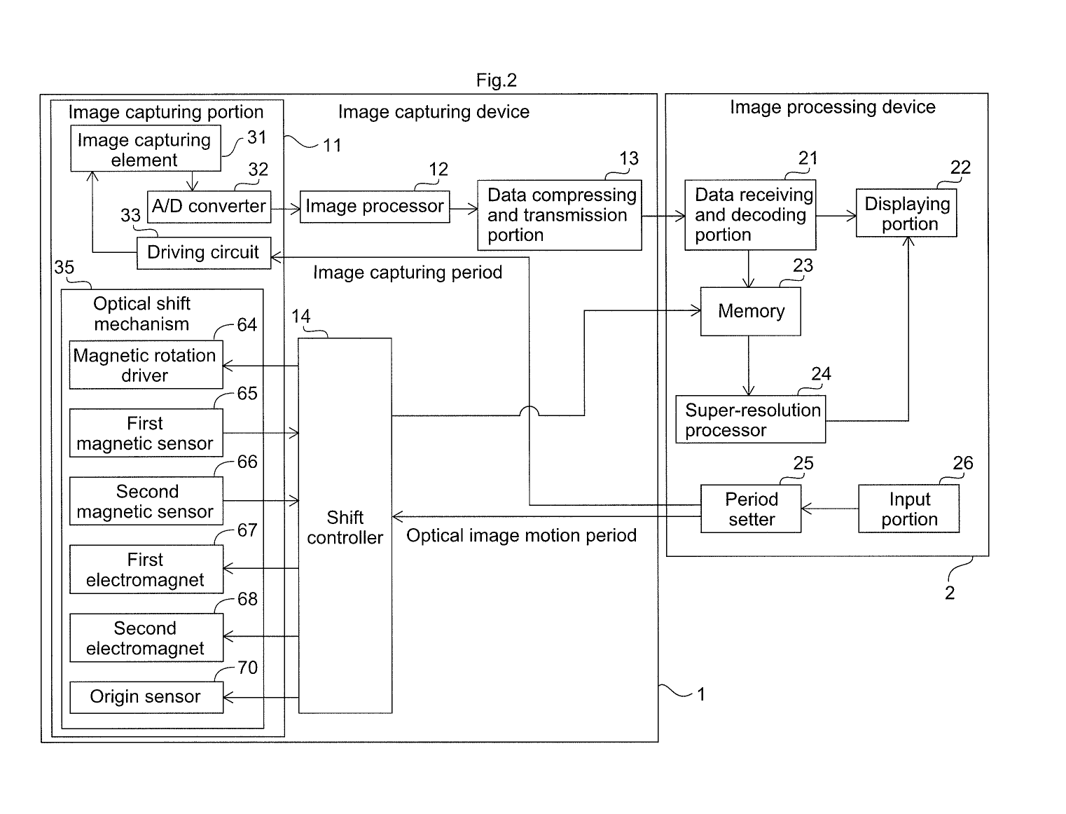

FIG. 2 is a block diagram illustrating a schematic configuration of the image capturing device 1 and the image processing device 2 shown in FIG. 1. As shown in FIG. 2, the image capturing device 1 has an image capturing portion 11, an image processor 12, a data compressing and transmitting portion 13, and a shift controller 14. The image capturing portion 11 has an image capturing element 31 that performs photoelectric conversion of light from an object and outputs an analog pixel signal. The image capturing element 31 is a two-dimensional CMOS image sensor. Alternatively, a two-dimensional CCD image sensor may be used for the image capturing element 31.

The analog signal output from the image capturing element 31 is converted into a digital signal in an A/D converter 32. The digital signal is input into the image processor 12 where processing such as color correction, a demosaicing processing, tone correction (γ correction), a YC separation processing and the like is performed, and converted into an image data. The data compressing and transmitting portion 13 performs compression processing such as by H.264, MPEG4 or the like on the image data, and thereafter transmits the data to the image processing device 2.

The image capturing portion 11 has an optical shift mechanism 35 that slightly displaces optical images formed on a light-receiving surface of the image capturing element 31 and the image capturing element 31 relative to each other. The shift controller 14 controls operations performed by each component of the optical shift mechanism 35.

A configuration of the optical shift mechanism 35 and a control by the shift controller 14 are described in detail later, and only an outline thereof is explained here. A rotation body (see numerical reference 53 in FIG. 4) having an optical member (see numerical reference 51 in FIG. 4) that slightly displaces optical images is rotationally driven by a magnetic rotation driver 64, and a position of the rotation body in radial and axial directions is detected by a first magnetic sensor 65 and a second magnetic sensor 66. A position of the rotation body in the radial and axial directions is controlled by a first electromagnet 67 and a second electromagnet 68. An origin of a rotation position of the rotation body is detected by an origin sensor 70 (viscosity increase detector).

The rotation body is provided with magnetizers (see numerical references 61 and 62 in FIG. 4). The first magnetic sensor 65 and the second magnetic sensor 66 detect magnetism of the magnetizers and output data to the shift controller 14. The shift controller 14 controls the magnetic rotation driver 64 based on the position information of the rotation body indicated by the output from the first magnetic sensor 65 and the second magnetic sensor 66 so as to rotate the optical member. The shift controller 14 also controls the first electromagnet 67 and the second electromagnet 68 so as to keep the optical member at a predetermined position.

The image processing device 2 includes a data receiving and decoding portion 21, a displaying portion 22, a memory 23, a super-resolution processor 24, a period setter 25, and an input portion 26. The image processing device 2 may be formed by installing required application software in an information processing device such as a personal computer, a work station, or the like. Alternatively, the image processing device 2 may be an exclusive or dedicated device such as a CCTV recorder.

In the image processing device 2, the compressed image data transmitted from the image capturing device 1 is received and decoded by the data receiving and decoding portion 21, and thereafter converted into image data of RGB so as to be displayed in real time on the displaying portion 22 including a display and the like. Further, the image data of RGB is sent to the memory 23 including a hard disc drive device and the like, and temporarily stored so as to be read out from the memory 23 and displayed on the displaying portion 22 as needed.

In a case where a high-resolution image is needed, for example, to investigate a traffic accident or the like, the image data is read out from the memory 23; super-resolution processing is performed on the data in the super-resolution processor 24 so as to generate a high-resolution image (stationary image); and the high-resolution image is displayed on the displaying portion 22. As described later, the super-resolution processing generates a high-resolution image by use of a pixel shift (movement) among a plurality of frame images. With the optical shift mechanism 35 being provided to an image capturing device, a low-resolution image can be made into a high-resolution image regardless of whether the image capturing object is in motion or in pause (i.e., is stationary).

The input portion 26, described in detail later, receives an input of an image capturing period from a user, and sends the input image capturing period to the period setter 25. The period setter 25 determines a circular motion (i.e., rotation) period based on the image capturing period transmitted from the input portion 26, and transmits a command signal regarding the circular motion period to the image capturing device 1. The shift controller 14 of the image capturing device 1 operates the optical shift mechanism 35 based on the command signal regarding the circular motion period so as to rotationally drive the optical member at a rotation speed corresponding to the indicated circular motion period.

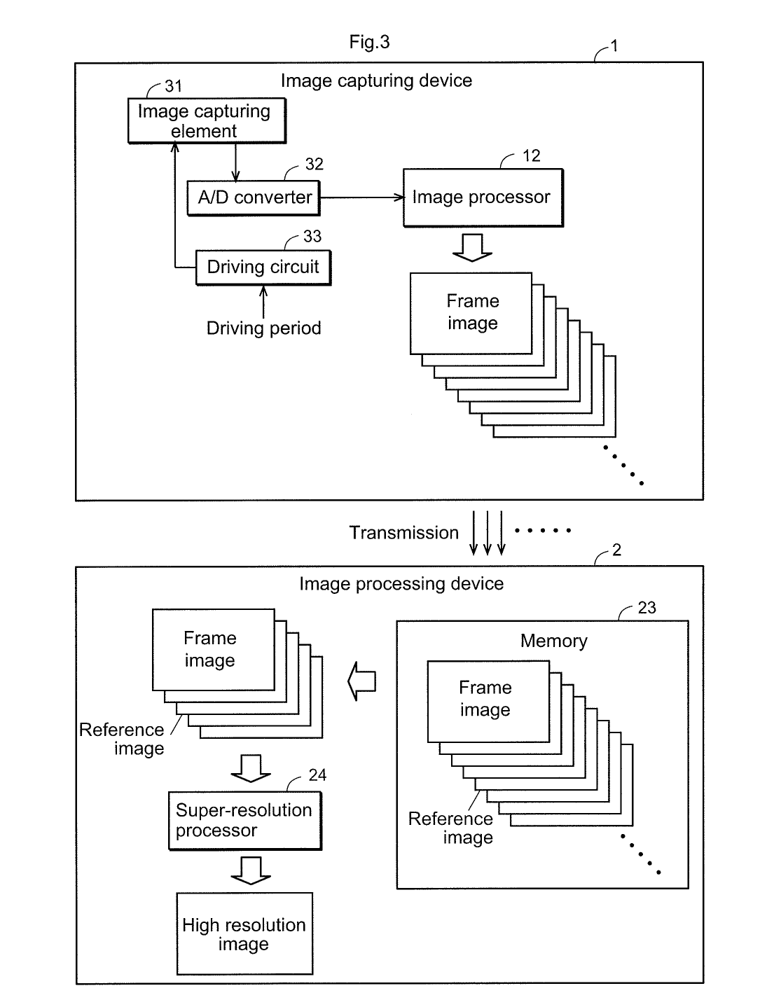

FIG. 3 is a schematic diagram illustrating processing status in the image capturing device 1 and the image processing device 2. As shown in FIG. 3, the image capturing element 31 is driven by a driving circuit 33, and image capturing (sampling) is performed at a predetermined period (hereinafter, image capturing period) corresponding to a timing signal generated by the driving circuit 33. For example, when 30 sets of frame images are generated per second, i.e., at a rate of 30 frames/sec, the image capturing period is set at around 30 ms.

In the super-resolution processor 24 of the image processing device 2, super-resolution processing is performed to generate high-resolution images from a plurality of frame images which are temporally consecutive. In the super-resolution processing, first, the frame images stored in the memory 23 are displayed as stationary images by frame-by-frame playback. Next, when a user designates a reference image from the images, a frame image as the reference image and a plurality of previous and subsequent frame images of the reference image are read out from the memory 23 and sent to the super-resolution processor 24 so as to undergo super-resolution processing.

The super-resolution processing may employ, for example, an ML (Maximum-likelihood) method, a MAP (Maximum A Posterior) method, a POCS (Projection On to Convex Sets) method, or the like, and is performed by executing application software in a CPU. In general, super-resolution processing requires a large amount of computing, and thus a part of the processing may be performed by using a GPU (Graphic Processing Unit) or an exclusive hardware.

Herein, the ML method refers to a method that uses a square of an error between the pixel value of the low-resolution image estimated based on the high-resolution image and the actually observed pixel value as an evaluation function, and adopts a high-resolution image that minimizes the evaluation function as an estimated image. In sum, the ML method is a super-resolution processing method based on the principle of the most-probable estimation. The MAP method refers to a method that estimates a high-resolution image that minimizes an evaluation function in which probability information of the high-resolution image is added to a square of the error. In sum, the MAP method is a super-resolution processing method that estimates a high-resolution image as an optimization issue to maximize the posterior probabilities by using prospective information with respect to the high-resolution image. The POCS method is a super-resolution processing method that obtains a high-resolution image by forming simultaneous equations regarding the pixel values of the high-resolution image and the low-resolution image, and solving the equations sequentially. Of course, other super-resolution processing methods can be used.

These super-resolution methods include a process in which a high-resolution image is assumed, the pixel values of all low-resolution images are estimated from the assumed high-resolution image based on a point spread function (PSF function) obtained from a camera model, and a high-resolution image that reduces the difference between the estimated value and the observed pixel values (observed values) are searched. Therefore, these super-resolution methods are called reconstruction-based super-resolution processing.

Herein, the process for searching for the high-resolution image is to confirm where each pixel obtained as the low-resolution image is located in the high-resolution image, and it is called a “positioning” process. In general, in a super-resolution processing, the positioning process is carried out repeatedly and broadly with respect to the vicinity of the focused pixel so as to achieve a high resolution even in a case where variation in the pixel positions among a plurality of low-resolution images is unclear. Consequently, it is known that the calculation cost becomes extremely high. In contrast, as described in detail later, according to the present invention, the position of the pixel shifted by the optical shift mechanism 35 is known, and each frame image, i.e., a low-resolution image is captured in the known position. With respect to at least a stationary object, therefore, it becomes possible to omit most of the positioning processes by the optical shift, which results in great reduction in the calculation cost.

Incidentally, a super-resolution processing using image information over a plurality of temporally consecutive frames is specifically called a multi-frame reconstruction-based super-resolution processing. On the other hand, in a case where reconstruction-based super-resolution processing is performed in a single frame, it is called one frame reconstruction-based super-resolution. The present embodiment employs multi-frame reconstruction-based super-resolution.

Herein, a high-resolution image achieved by the super-resolution processing by the image processing device 2 is reproduced as a stationary image. When the processing capacity of the image processing device 2 is sufficiently high, however, it is also possible to reproduce a moving image using high-resolution images obtained by the super-resolution processing as frame images.

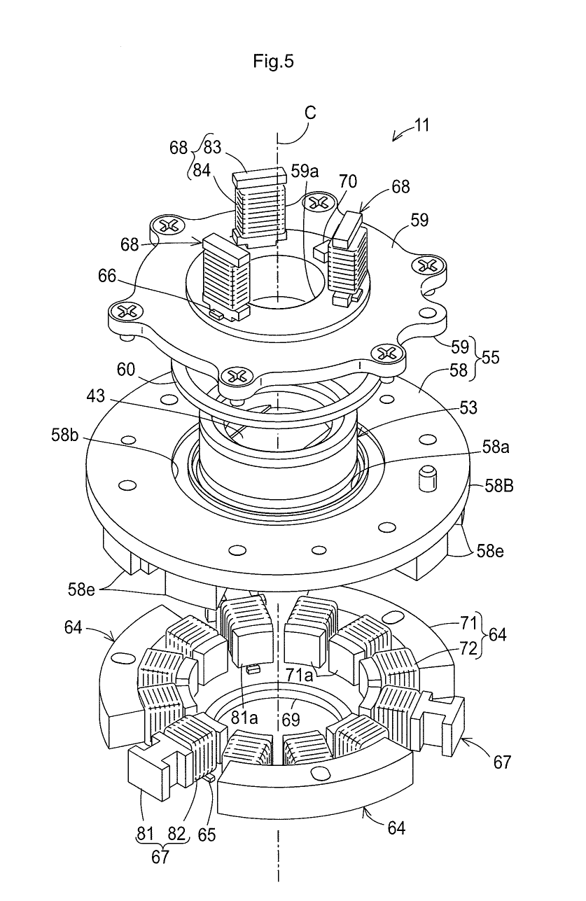

FIG. 4 is a longitudinal cross-sectional view showing the image capturing portion 11 of the image capturing device 1. FIG. 5 is an exploded perspective view of the image capturing portion 11 shown in FIG. 4. As shown in FIGS. 4 and 5, the image capturing portion 11 of the image capturing device 1 includes a sensor module 41, a lens unit 42, and an optical shift mechanism 35. The sensor module 41 is provided with an image capturing element 31. The lens unit 42 forms an image based on light from an object (not shown in the drawing) received on a light-receiving surface 31a of the image capturing element 31. The optical shift mechanism 35 displaces an optical image formed on the light-receiving surface 31a of the image capturing element 31.

The optical shift mechanism 35 includes a rotation body 53 and a rotational driving device 54. The rotation body 53 is configured with an optical member 51 and a supporting ring 52 that is provided on an outer peripheral side of the optical member 51. The rotational driving device 54 rotationally drives the rotation body 53. The rotation body 53 is received in an optical capsule (capsule member) 55, in which a liquid 56 is contained. The rotation body 53 is provided in the liquid 56 in a floating state while being displaceable in axial and radial directions, and rotationally driven by the rotational driving device 54. The details of the rotational driving device 54 are described later.

The optical capsule 55 includes a lower portion 58 that is provided on a lower side of the optical capsule 55, and an upper portion 59 that is provided on an upper side thereof. The lower portion 58 has a closed-bottom tubular portion 58A and a ring flange 58B. The closed-bottom tubular portion 58A forms, at the center of the upper surface thereof, a circular-shaped upper surface concave portion 58a. The ring flange 58B is provided to an upper edge of the closed-bottom tubular portion 58A. The upper portion 59 covers the upper surface concave portion 58a. A groove 58b having an annular shape is provided to the upper surface of the ring flange 58B of the lower portion 58 on an outer side of the upper surface concave portion 58a. With a sealer 60 being provided in the groove 58b, the lower portion 58 and the upper portion 59 are fastened to each other by use of a plurality of screws (six screws, in this example). Thereby, the lower portion 58 and the upper portion 59 integrally form the optical capsule 55 having an enclosed space S therein.

The enclosed space S formed by the optical capsule 55 has a cross section that is narrow in the center. The enclosed space S includes a central portion Sa that forms a space having a circular plate shape with the optical axis C as a center; and an outer annular portion Sb that connects to the outer peripheral side of the central portion Sa and vertically extends so as to have a substantially rectangular cross section. In the enclosed space S of the optical capsule 55, the central portion Sa houses the parallel plate 43, and the outer annular portion Sb houses the supporting ring 52 and other components.

A lower surface concave portion 58c (see FIG. 4), an annular convex portion 58d, and a plurality of convex portions 58e (see FIG. 5) are each formed on the lower surface of the lower portion 58 of the optical capsule 55. The lower surface concave portion 58c is provided at the center of the bottom wall of the closed-bottom tubular portion 58A. The annular convex portion 58d protrudes downward at the peripheral edge of the bottom wall of the closed-bottom tubular portion 58A. The plurality of convex portions 58e are provided at predetermined locations on the ring flange 58B. The sensor module 41 is attached to the lower surface concave portion 58c. Components of the optical shift mechanism 35 are each installed inside the annular convex portion 58d and among the convex portions 58e.

On the upper surface of the upper portion 59 of the optical capsule 55, a central concave portion 59a is provided at the center thereof, and a plurality of outer concave portions 59b are provided around the central concave portion 59a at equal distance from one another. The lens unit 42 is attached to the central convex portion 59a. Components of the optical shift mechanism 35 are each attached to the outer concave portions 59b.

The optical capsule 55 is made of a transparent material with a high magnetic permeability rate and a relatively high thermal conduction rate such as a resin, a glass material, or the like. Resins such as polycarbonate, acryl, cyclic olefin copolymer (COC), cyclic olefin polymer (COP) or the like may be used. The entire body of the optical capsule 55 does not need to be made of a transparent material, as long as a portion corresponding to a light path where incident light from the lens unit 42 passes through is made of the transparent material described above. The area other than the light path of the optical capsule 55 may be non-transparent (for example, black), thereby making it possible to prevent unwanted light, in other words, stray light, from entering the image capturing element 31.

The optical member 51 has a substantially circular plate shape, and is provided at the center thereof with a parallel plate 43 that is inclined at a predetermined angle with respect to an optical axis C of the lens unit 42. With the parallel plate 43 rotating, it is possible to slightly displace an optical image formed on the light-receiving surface 31a of the image capturing element 31 relative to the image capturing element 31. A material that forms the optical member 51 is not limited to optical glass, and other materials such as an acrylic resin or the like may be used.

A liquid having a higher refractive index than that of the air and a lower refractive index than that of the parallel plate 43 is employed for the liquid 56 that is filled inside the optical capsule 55. Accordingly, a shift width of the parallel plate 43 becomes substantially narrower than that of the parallel plate 43 if it were provided in the air. Therefore, it is possible to suppress an amount of change in the optical shift that occurs when a center axis of the parallel plate 43 is inclined due to vibration and the like of the optical member 51 in the optical capsule 55.

For the liquid 56 filled in the optical capsule 55, anti-freeze solution (a mixture of water and polypropylene glycol or ethylene glycol, for example) is used. Thereby, it is possible to expand a temperature range (up to −20° C., for example) in which an image capturing device 1 can be used. Further, with increased viscosity of the liquid 56, cushioning effect against outside impacts is improved. Thus, it is possible to suppress variation of optical shift amount due to vibration of the image capturing device 1 and also prevent the optical member 51 from being damaged. Furthermore, the refractive index of the liquid 56 can easily be adjusted by changing density of the anti-freeze solution, therefore desired optical shift amount can easily be obtained.

The supporting ring 52 has a circular ring shape, and is provided with a first ring 52a, a second ring 52b, and a third ring 52c. The first ring 52a is provided in the central portion in the axial direction of the supporting ring 52 and holds the optical member 51 on the inner peripheral side thereof. The second ring 52b is fixed to the upper end surface of the first ring 52a with an adhesive. The third rind 52c is fixed to the lower end surface of the first ring 52a with an adhesive. The first ring 52a has a rectangular cross section. The second ring 52b and the third ring 52c each have a rectangular cross section having a same radius as that of the first ring 52a, and are provided so as to be concentric with the first ring 52a.

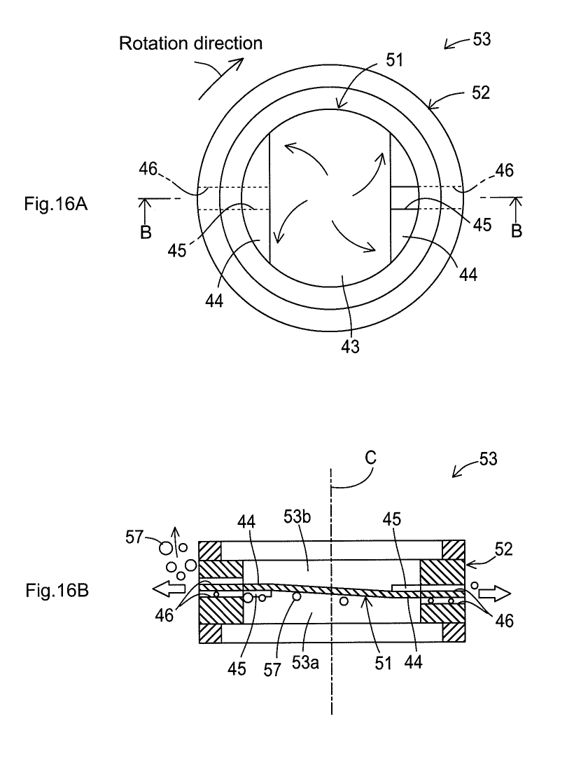

When the supporting ring 52 is configured as described above, the rotation body 53 is provided with concave portions 53a and 53b (see FIG. 16) on both sides in the axial direction, and thus has an H-shaped cross section.

Each of the first ring 52a, the second ring 52b, and the third ring 52c is a plastic magnet made of polyphenylene sulfide (PPS) resin in which minute magnetic particles are dispersed and mixed. Thus, water absorption and swelling of the first, second and third rings 52a, 52b and 52c can be reduced even in the liquid 56 that contains water. Also, by using the same resin material for both the plastic magnet and a binder, it is possible to fix the second and third rings 52b and 52c onto the first ring 52a with an adhesive having high adhesion property to both members to be fixed. Thus, a long-term use dependability is improved. Similarly, with the same material being used for the optical member 51 and the binder of the first ring 52a, it is possible to increase adhesion property when the optical member 51 and the supporting ring 52 are fixed to each other, thereby making it possible to improve the long-term use dependability. Although the first ring 52a, the second ring 52b, and the third ring 52c are shown as separate members in FIG. 4, the rings are made of the same material (PPS). Thus, they may be integrally formed and then magnetized to obtain a magnetic capability, as described later.

Herein, neodymium is used as the magnetic particles of the first ring 52a, the second ring 52b, and the third ring 52c. A neodymium magnet has an extremely large magnetic force and provides a large driving torque, therefore it is effective when the viscosity of the liquid 56 becomes large at low temperature. However, since the neodymium becomes oxidized by water and generates rust, the surface of the supporting ring 52 is coated with a resin material in order to prevent the supporting ring 52 from contacting the liquid 56. The coating with the resin material may be applied before or after the second and third rings 52b and 52c are fixed to the first ring 52a.

The liquid 56 filled in the optical capsule 55 is not limited to anti-freeze solution. It is possible to fill the optical capsule 55 with another fluid, such as water, for example, as long as the fluid has a higher refractive index than that of the air and a lower refractive index than that of the parallel plate 43. Also, the anti-freeze solution does not need to be water-based. For example, transparent silicone oil may be employed. Because there is no likelihood that rust will occur in the supporting ring 52 or the like when the transparent silicone oil is employed, an anti-rust treatment such as a resin coating or the like is not necessary.

The material of binder used for the first ring 52a, the second ring 52b, and the third ring 52c is not limited to PPS, and for example, a polyamide resin such as 6-nylon or the like may be used. Also, different types of resin may be used for the binder of each of the first ring 52a, the second ring 52b, and the third ring 52c. Further, the magnetic particles used for the first ring 52a, the second ring 52b, and the third ring 52c are not limited to the neodymium, and it is possible to use, for example, ferrite, samarium cobalt, or the like. Also, different types of magnetic particles may be used for each of the first ring 52a, the second ring 52b, and the third ring 52c. When the ferrite is used as the magnetic particles, the above-mentioned resin coating or the like is not needed since there is no likelihood of rusting.

The rotational driving device 54 includes a first magnetizer 61, a second magnetizer 62, a third magnetizer 63, a magnetic rotation driver 64, a first electromagnet (first position controller) 67, a second electromagnet (second position controller) 68, and a permanent magnet 69. The first magnetizer 61 is provided to a central portion of the first ring 52a in the axial direction so as to face an outer peripheral surface of the supporting ring 52 in the radial direction. The second magnetizer 62 is provided to the second ring 52b so as to face an upper end side of the supporting ring 52 in the axial direction. The third magnetizer 63 is provided to the third ring 52c so as to face a lower end side of the supporting ring 52 in the axial direction. The magnetic rotation driver 64 rotates the rotation body 53 by applying a magnetic force in the rotation direction onto the first magnetizer 61. The first electromagnet 67 controls a position of the rotation body 53 in the radial direction by applying a magnetic force in the radial direction to the first magnetizer 61. The second electromagnet 68 controls a position of the rotation body 53 in the axial direction by applying a magnetic force in the axial direction to the second magnetizer 62. The permanent magnet 69 applies a magnetic force in the same direction as that of the second electromagnet 68 to the third magnetizer 63 so as to maintain the rotation body 53 at a predetermined position in the axial direction.

The rotational driving device 54 further includes a first magnetic sensor 65 and a second magnetic sensor 66. The first magnetic sensor 65 detects a position of the rotation body 53 in the radial direction based on magnetism of the first magnetizer 61. The second magnetic sensor 66 detects a position of the rotation body 53 in the axial direction based on magnetism of the second magnetizer 62. The first electromagnet 67 controls a position of the rotation body 53 in the radial direction based on a detection result from the first magnetic sensor 65. The second electromagnet 68 controls a position of the rotation body 53 in the axial direction based on a detection result from the second magnetic sensor 66.

The first magnetizer 61, more specifically, is magnetized in a polar anisotropic orientation on the outer peripheral side of the first ring 52a so as to face the central portion, except both ends in the axial direction, of an outer peripheral surface of the first ring 52a. Thus, the first ring 52a becomes a permanent magnet having a complete magnetic circuit inside thereof. Accordingly, most magnetic force generated by the first magnetizer 61 can be applied to the opposing first electromagnet magnet 67. Therefore, compared with the magnetization in a radially anisotropic orientation, the magnetic force of the first electromagnet 67 can be made stronger, thereby making it possible to increase the accuracy in controlling the rotation body 53 in the radial direction. A surface magnetic flux density on the outer peripheral surface of the first magnetizer 61 sinusoidally changes in association with a displacement in the circumferential direction. Therefore, it is possible to highly accurately detect a rotation angle of the rotation body 53. Accordingly, the driving electric current can be controlled based on the detected rotation angle so as to inhibit cogging and the like, thereby making it possible to highly accurately control a rotational driving of the rotation body 53.

Further, the first ring 52a and the optical member 51 may be integrally molded by making the inner diameter of the first ring 52a smaller than the outer diameter of the optical member 51, and placing the optical member 51 in a mold when the first ring 52a is formed. The integral molding prevents the optical member 51 from being separated from the supporting ring 52 due to deterioration of an adhesive or the like, thereby improving a long-term use dependability.

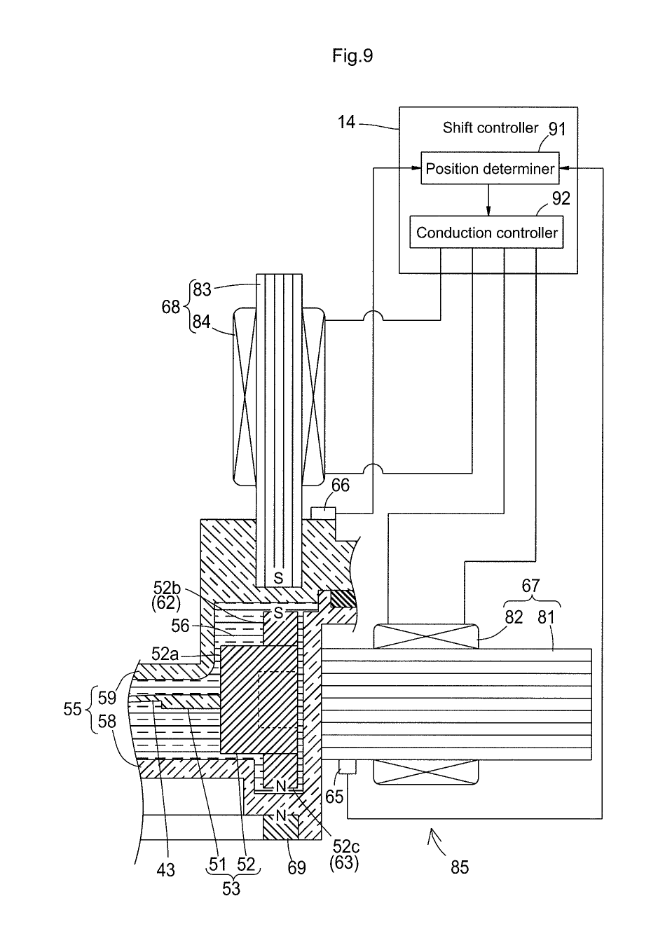

The second magnetizer 62 and the third magnetizer 63 form an oriented magnet field in a vertical direction. By aligning magnetic easy axes of magnetic particles at the time of shaping the rings (plastic magnets), magnetization is made in an anisotropic orientation so that the entire upper surfaces of the second and third rings 52b and 52c are magnetized with south poles, and the lower surfaces thereof are magnetized with north poles (see FIG. 9), thereby making the second and third rings 52b and 52c permanent magnets.

By configuring the supporting ring 52 as described above, an unmagnetized portion exists between the first magnetizer 61, and the second and third magnetizers 62 and 63, which acts as a back yoke that is likely to be a magnetic path. As described earlier, while the second ring 52b and the third ring 52c have a uniform distribution of magnetic flux density in the circumferential direction, the first magnetizer 61 has a distribution of magnetic flux density (in polar anisotropic orientation) that sinusoidally changes in the circumferential direction. This causes the accuracy in controlling the position of the rotation body 53 in the axial direction to decrease when a magnetic field of the first magnetizer 61 affects the second magnetizer 62 and the third magnetizer 63. However, with the unmagnetized portion existing between the first magnetizer 61 and the second and third magnetizers 62 and 63, it becomes unlikely for the magnetic field of the first magnetizer 61 to impact the second and third magnetizers 62 and 63, thereby making it possible to highly accurately control the position of the rotation body 53 in the axial direction.

The supporting ring 52, which configures a portion of the rotational driving device 54, is directly connected to the optical member 51 without employing another member, such as a back yoke. Therefore, it is possible to reduce adhered areas in the rotation body 53 as well as the entire size of the rotation body 53.

Also, the rotation body 53 is simply configured by installing the first ring 52a, the second ring 52b, and the third ring 52c to the optical member 51, thereby making it possible to improve the sealing property of the optical capsule 55. Also, increased independency of the optical capsule 55 as a member is advantageous in a manufacturing process.

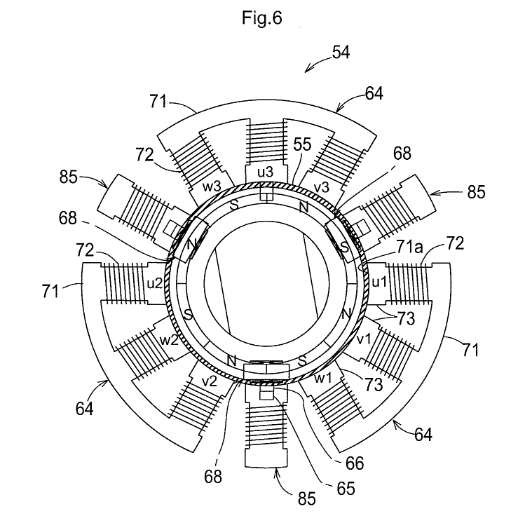

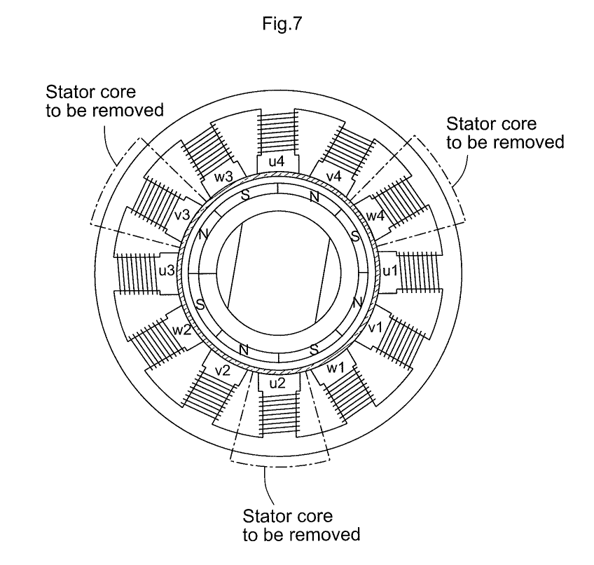

FIG. 6 is a plan view of an optical shift mechanism 35 shown in FIG. 4. FIG. 7 is a plan view showing one example of applying a conventional configuration of a three-phase motor, which is used as a base of the rotational driving device 54 shown in FIG. 6. As shown in FIGS. 4 and 6, the magnetic rotation driver 64 is provided with a stator core 71 that is configured with multilayer electromagnetic steel laminations, and a coil 72 that is wound around the stator core 71. The stator core 71 is provided so as to oppose the first magnetizer 61 with the optical capsule 55 in between. An opposing surface 71a, which opposes the first magnetizer 61, is provided to the curved surface along the outer peripheral surface of the optical capsule 55. The opposing surface 71 a is provided in contact with the outer peripheral surface of the optical capsule 55.

Herein, the contact does not only mean a physical contact but also a thermodynamic connection that enables an effective thermal conductivity. Specifically, a thermal conductor (not shown in the drawings) is provided between the stator core 71 and the optical capsule 55 in order to thermodynamically connect them to each other. Thereby, the stator core 71 is firmly attached to the optical capsule 55, and the magnetic rotation driver 64 can be used to heat the liquid 56. Silicon grease is used as a thermal conductor here. The opposing surface 71 a is applied with the silicon grease and then firmly attached to the outer peripheral surface of the optical capsule 55 so that the stator core 71 is thermodynamically connected to the optical capsule 55. With the stator core 71 and the optical capsule 55 being physically in contact to each other, the position of the stator core 71 that abuts the optical capsule 55 is decided at least in the radial direction of the optical capsule 55 as long as dimensions of the optical capsule 55 are accurately kept. Therefore, it is possible to reduce variation of magnetic force applied to the rotation body 53.

In a case where no thermal conductor is provided, even when the opposing surface 71a of the stator core 71 is formed to fit along the outer surface of the optical capsule 55, it is difficult for the entire opposing surface 71 a of the stator core 71 to physically contact the outer peripheral surface of the optical capsule 55 due to a manufacturing tolerance of the optical capsule 55 and the stator core 71. Therefore, air, which has extremely low thermal conductivity, exists between the opposing surface 71 a of the stator core 71 and the outer peripheral surface of the optical capsule 55, thus heat cannot be effectively transferred from the stator core 71 to the optical capsule 55.

By contrast, when a thermal conductor is provided in between as in the present embodiment, heat generated by conduction of the coil 72 and heat generated by magnetic reluctance of the stator core 71 associated with generation of magnetic field by the coil 72, can be transferred to the optical capsule 55 side by use of the entire opposing surface 71a of the stator core 71 as a heat conduction path. Thus, the liquid 56 can be heated with a greater amount of heat energy. With the increased efficiency in heating the liquid 56, it is possible to prevent viscosity of the liquid 56 from increasing at low temperature, thereby making it possible to stably rotate the rotation body 53 even in a cold environment. Further, the magnetic rotation driver 64 may be used to heat the liquid 56. Thus, an exclusive component for heating may be eliminated or only a small component that produces a small amount of heat is required, thereby making it possible to reduce the number of components or the size of the device.

The rotational driving device 54 is an inner-rotor type three-phase motor. As shown in FIG. 6, the first magnetizer 61, which generates a magnetic field system, has eight magnetic poles that are alternately magnetized to be a north pole or a south pole along the circumferential direction. Three magnetic rotation drivers 64 are provided at equal distance from one another. Three teeth 73 are provided to each stator core 71. As shown in FIG. 7, the rotational driving device 54 is configured to have nine stators and eight poles. This configuration is attained by removing three equally-spaced stator cores, each having one tooth, from the conventional three-phase motor having twelve stators and eight poles.

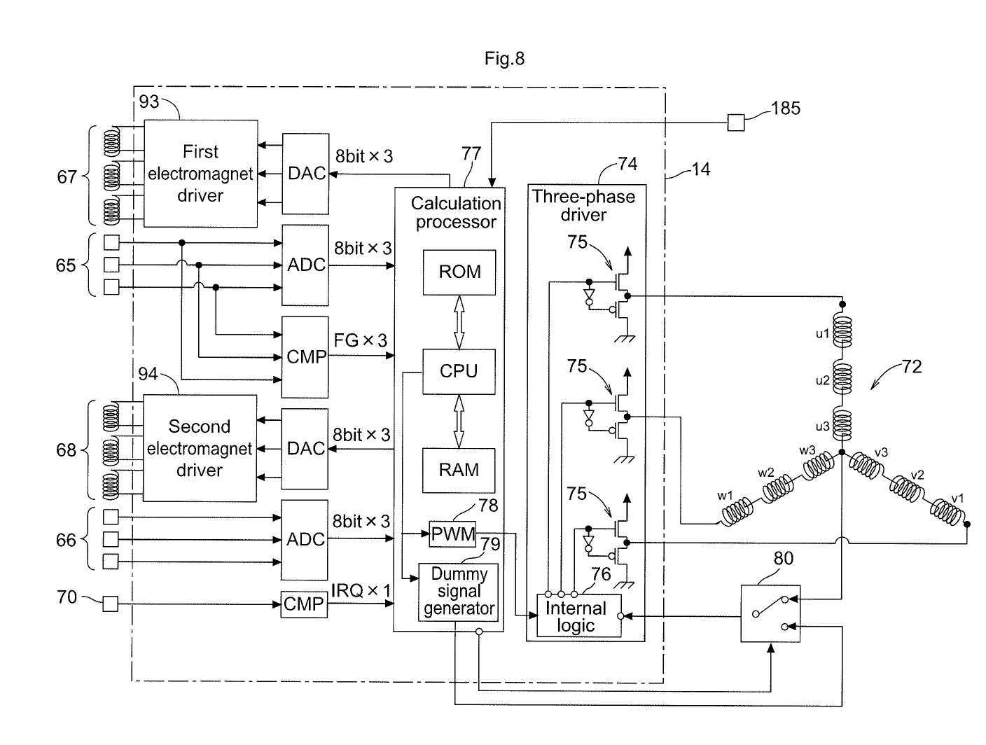

The coil 72 of the magnetic rotation driver 64 is connected in a star connection (see FIG. 8). Three coils 72 provided to each stator core 71 are each set to be either one of u-phase, v-phase, and w-phase. Since all the u-phase, the v-phase, and the w-phase exist on each stator core 71, there is no braking timing, thereby achieving high motor efficiency. Further, it is possible to keep larger spaces among the teeth 73 from one another without enlarging the outer diameter of the stator core 71. Therefore, it is easy to wind the coil 72, thereby improving efficiency in production while saving space.

When the coil 72 of the magnetic rotation driver 64 is conductive, and thus the magnetic rotation driver 64 is excited, attractive and repulsive forces are generated between the first magnetizer 61 and the magnetic rotation driver 64, thereby making it possible to rotate the rotation body 53 without contacting the rotation body 53 in the optical capsule 55. This configuration, which employs a magnetic force, is similar to the configuration of a bearingless motor. With no sliding member existing, this configuration enables to drive the rotational driving device 54 with extremely small vibration, and to attain a long operating life.

FIG. 8 illustrates a configuration of a shift controller 14 shown in FIG. 2. As shown in FIG. 8, the coil 72 in the magnetic rotation driver 64 is driven by a three-phase driver 74 provided to the shift controller 14. In the shift controller 14, a speed command value is transmitted from a calculation processor 77 to a pulse width modulator (PWM) 78. The pulse width modulator 78 calculates on-duty ratio based on the speed command value, and outputs the PWM signal to the three-phase driver 74 after performing a pulse width modulation on the signal based on the duty ratio. An output from a temperature sensor 185 (viscosity increase detector), which is appropriately placed on the image capturing device 1, is input into the calculation processor 77.

The three-phase driver 74 is provided inside thereof with a three-system push-pull type transistor circuit 75 and an internal logic 76. The internal logic 76 is connected to each transistor circuit 75 and to a neutral point of the star connection through a switch 80. While checking an electric current flowing through the coil 72, the internal logic 76 controls an electric current flowing through each phase of the coil 72 based on the PWM signal. Thereby, the rotation body 53 is rotationally driven with a circular motion period directed by the period setter 25 (See FIG. 2).

The switch 80 is a one-circuit two-contact switch, which switches a source of an electric current signal input into the internal logic 76 inside the three-phase driver 74. In the switch 80, one point of contact is connected to the neutral point of the coil 72, and the other contact is connected to a dummy signal generator 79 provided in the calculation processor 77. The switch 80 is switched by the calculation processor 77, and is connected to the neutral point side of the coil 72, as shown in FIG. 8, in a normal condition (when the viscosity of the liquid 56 is not high enough to interfere with the rotational driving of the rotation body 53).

From the neutral point of the star-connected coil 72, the common signal (electric current signal) that monitors a value of the electric current flowing through the coil 72, which is set to be three-phase, is input to the internal logic 76. The internal logic 76 controls each of the transistor circuits 75 so as to switch the direction of the current to flow through the coil 72 with reference to the input common signal.

A decrease in temperature around the image capturing device 1 results in a decrease in temperature of the liquid 56 inside the optical capsule 55, thereby increasing the viscosity of the liquid 56. With the viscous resistance of the liquid 56, the rotation speed of the rotation body 53 decreases. When the viscosity of the liquid 56 keeps increasing, the rotation body 53 eventually stops to rotate (in a situation where a part of the liquid 56 freezes). In such a situation, the common signal cannot be switched, thus an electric current continues to flow in a certain direction though the coil 72 of a phase that is being excited. As described above, the magnetic rotation driver 64, in which the coil 72 and the stator core 71 generate heat by being conductive, acts to heat the liquid 56. With a constant electric current flow, however, the magnetic rotation driver 64 generates heat only at a part of phases, thus heat is increased at only a portion of the liquid 56 which viscosity has been increased. In such a case, there is likelihood that only a portion of the magnetic rotation driver 64 generates unusually high heat, thus it is undesirable.

To address the above circumstance, when the CPU detects that there is no output from the origin sensor 70, which detects rotation of the rotation body 53, over a predetermined time period, the calculation processer 77 sends out a signal to the dummy signal generator 79 to initiate an operation thereof, and at a same time, sends out a switching signal to the switch 80. Upon receiving the switching signal, the switch 80 switches to connect to the other side, namely, the dummy signal generator 79, so that a signal output from the dummy signal generator 79 is input into the internal logic 76 of the three-phase driver 74. The dummy signal generator 79 generates and outputs an electric current signal as a dummy signal, which is the same as the common signal generated when the rotation body 53 is rotationally driven with a directed circular motion period.

Consequently, the internal logic 76 of the three-phase driver 74 switches a flow of the electric current flowing through the coil 72 as if the rotation body 53 were rotating with the directed circular motion period, despite the fact that the rotation body 53 is not rotating with the directed circular motion period. Thereby, the magnetic rotation driver 64 evenly generates heat in all the phases and evenly heats the liquid 56 with increased viscosity.

Alternatively, the calculation processor 77 may be configured to cause the CPU to monitor whether or not a temperature detected by the temperature sensor 185 has dropped to a predetermined temperature that affects the rotational speed of the rotation body 53 due to the viscosity of the liquid 56. When the CPU detects that an output from the temperature sensor 185 has fallen below a predetermined temperature, the calculation processor 77 causes the dummy signal generator 79 to generate a dummy signal, and also causes the switch 80 to switch. Further, in another possible configuration, outputs from both the origin sensor 70 and the temperature sensor 185 may be monitored, and a signal to input into the internal logic 76 may be switched when either one of the outputs meets a predetermined condition.

After a dummy signal is input into the internal logic 76 based on the output of the origin sensor 70 as described above, when the CPU detects periodic outputs from the origin sensor 70 within a predetermined period of time, the calculation processor 77 outputs a switching signal again to the switch 80 so that a common signal from the neutral point of the star-connected coil 72 is input into the internal logic 76 and the operation of the dummy signal generator 79 is stopped.

With the shift controller 14 performing such a control, even when the liquid 56 becomes cold and increases its viscosity, the entire liquid 56 can be evenly heated, thereby making it possible to avoid the circumstance where a portion of the magnetic rotation driver 64 generates extraordinary heat.

As shown in FIG. 4, the first electromagnet 67 includes a first magnetic body 81 that opposes the first magnetizer 61, and a coil 82 that is wound around the first magnetic body 81. The first magnetic body 81 is configured with multilayer electromagnetic steel laminations in order to suppress an overcurrent, and is inserted among the convex portions 58e (See FIG. 5) and abuts the outer peripheral surface of the optical capsule 55. Similar to the stator core 71 of the magnetic rotation drive 64, the first magnetic body 81 of the first electromagnet 67 has an opposing surface 81 a that opposes the first magnetizer 61 and is formed on the curved surface along the outer peripheral surface of the optical capsule 55. With silicon grease being applied, the opposing surface 81 a is closely attached to the outer peripheral surface of the optical capsule 55, and thus the entire opposing surface 81a is thermodynamically connected to the optical capsule 55.

When the coil 82 of the first electromagnet 67 is conductive, and thus the first electromagnet 67 is excited, repulsive and attractive forces are generated between the first magnetizer 61 and the first electromagnet 67. Three first electromagnets 67 are provided around the optical capsule 55 at equal distance from one another (see FIG. 6). A radial-direction magnetic force applied to the rotation body 53 is adjusted by separately controlling conduction amount of each coil 82 in the first electromagnet 67, thereby making it possible to displace the rotation body 53 in the radial direction. Thus, the rotation body 53 is held at a predetermined position in radial direction, in other words, at a position in the radial direction where the center axis of the optical member 51 is substantially aligned with the optical axis C.

The second electromagnet 68 includes a second magnetic body 83 that opposes the second magnetizer 62, and a coil 84 that is wound around the second magnetic body 83. The second magnetic body 83 is configured with multilayer electromagnetic steel laminations in order to suppress an overcurrent. The second magnetic body 83 is inserted into the outer concave portion 59b and abuts a top outer surface of the optical capsule 55. In other words, an opposing surface 83a, which opposes the second magnetizer 62, of the second magnetic body 83 is formed on a flat surface along the top outer surface of the optical capsule 55. With silicone grease being applied, the opposing surface 83a is closely attached to the top outer surface of the optical capsule 55, and thus the entire opposing surface 83a is thermodynamically connected to the optical capsule 55. The second magnetic body 83 is installed in the optical capsule 55 in a state of being inserted into the outer concave portion 59b. Herein, the silicon grease is applied only to the opposing surface 83a of the second magnetic body 83 because it is preferable that a conduction path to the optical capsule 55 be closer to the liquid 56 in order to efficiently heat the liquid 56.

The permanent magnet 69 has a circular ring shape, and is provided on the side opposite to the second electromagnet 68 with the optical capsule 55 in between. The permanent magnet 69 is inserted into the annular convex portion 58d so as to abut the bottom outer surface of the optical capsule 55, and opposes the third magnetizer 63 with the optical capsule 55 in between.

The permanent magnet 69 and the third magnetizer 63 are provided in a state where mutually opposing sides thereof have a same magnetic pole (north pole, in this example, see FIG. 9) so that a repulsive force is generated between the permanent magnet 69 and the third magnetizer 63. Thus, the rotation body 53 is held in a floating state spaced away from the inner bottom surface of the optical capsule 55.

The second electromagnet 68 and the second magnetizer 62 are provided in a state where mutually opposing sides thereof have a same magnetic pole (south pole, in this example, see FIG. 9). When the coil 84 of the second electromagnet 68 conducts, and thus the second electromagnet 68 is excited, a repulsive force is generated between the second electromagnet 68 and the second magnetizer 62.

Three second electromagnets 68 are provided on a main surface of the optical capsule 55 at an equal distance from one another (see FIG. 6). Three permanent magnets 69 are provided on another surface of the optical capsule 55 at an equal distance from one another in the same circumferential direction as the second electromagnet 68 (so as to overlap in the optical axis direction). By controlling conduction amount of each coil 84 of the second electromagnet 68, a repulsive force generated between the second electromagnet 68 and the second magnetizer 62 is balanced with a repulsive force generated between the permanent magnet 69 and the third magnetizer 63. Thus, the rotation body 53 is held at a predetermined position in the axial direction.

As described above, since the second electromagnet 68 and the permanent magnet 69 act together to control the position of the rotation body 53 in the axial direction, it is possible to control the position of the rotation body 53 in the axial direction with ease and high accuracy. Herein, by equally controlling the conduction amount of each coil 84 of the second electromagnet 68, it is possible to displace the rotation body 53 in the axial direction to a position where the repulsive forces of the second electromagnet 68 and the permanent magnet 69 are balanced. Alternatively, by separately controlling the conduction amount of each coil 84 of the second electromagnet 68, it is also possible to control the rotation body 53 so as to suppress a swinging motion with the center line of the rotation body 53 being inclined with respect to the optical axis C. With the configuration described above, it is also possible, for example, to position the parallel plate 43 to be perpendicular to the optical axis C (optical shift is not generated in this state) and to actively control and change inclination angles so as to generate an optical shift. Even when the above-described parallel plate 43 is configured to be inclined at a predetermined angle with respect to the optical axis C, it is possible to directly adjust the amount of the optical shift by increasing or decreasing the incline angle. In addition, in a case where the lens unit 42 is configured with a zoom lens, it is possible to adequately control the amount of the optical shift.

Further, it is also possible to form a configuration, in which attracting forces are each generated and balanced between the second electromagnet 68 and the second magnetizer 62, and between the permanent magnet 69 and the third magnetizer 63. Particularly in the above-described configuration, in which a balance is created by use of repulsive forces, when the second electromagnet 68 is not excited, a repulsive force is generated between the permanent magnet 69 and the third magnetizer 63, and an attracting force is generated between the second electromagnet 68 (merely serving as a magnetic body as it is not excited) and the second magnetizer 62. As a result, the rotation body 53 is urged and abutted against the upper side in the optical axis direction in the drawings, and thus fixed inside the optical capsule 55. Thereby, it is possible to prevent the rotation body 53, especially the parallel plate 43, from being damaged due to shaking generated at a time of transporting an image capturing device, or the like.

It is preferable to employ a neodymium magnet for the permanent magnet 69. However, another type of magnet (ferrite magnet and the like, for example) may be used with consideration of a balance with magnetism of the second electromagnet 68 provided above.

With the first and second magnetic bodies 81 and 83 being installed in the optical capsule 55 in the manner described above, similar to the magnetic rotation driver 64, the first and second electromagnets 67 and 68 also act to heat the liquid 56. In other words, heat generated by the conduction of the coils 82 and 84, and heat generated by magnetic resistance of the first and second magnetic bodies 81 and 83 associated with generation of magnetic fields of the coils 82 and 84, are transferred to the liquid 56 via the optical capsule 55 by use of the entire surface of the opposing surfaces 81 a and 83a as heat conduction paths. Therefore, the liquid 56 is heated with a greater amount of thermal energy and thus prevented from lowering its temperature even when the ambient temperature drops. Further, similar to the magnetic rotation driver 64, in the first and second magnetic bodies 81 and 83, each of the opposing surfaces 81a and 83a has a shape to fit along the outer surface of the optical capsule 55, and abuts (contacts) the optical capsule 55 via silicone grease. Thereby, the liquid 56 is heated with increased heating efficiency (increasing the rate of heat transfer to the optical capsule 55).

The first magnetic sensor 65 is made of, for example, a Hall element or GMR (Giant Magneto Resistive) element. The first magnetic sensor 65 is provided to the first magnetic body 81, which configures the first electromagnet 67, on the lower surface thereof at the end on the first magnetizer 61 side. The first magnetic sensor 65 is integrated with the first electromagnet 67 by being fixed to the surface of the first magnetic body 81. With the first magnetic sensor 65 being placed in this way, a space between the coil 82 of the first electromagnet 67 and the optical capsule 55 can be effectively used, thereby making it possible to reduce the size of the device.

Similar to the first magnetic sensor 65, the second magnetic sensor 66 is made of, for example, a Hall element or GMR (Giant Magneto Resistive) element. The second magnetic sensor 66 is provided in proximity of the outer peripheral of the second magnetic body 83, which configures the second electromagnet 68 on the upper surface of the optical capsule 55. The second magnetic sensor 66 is integrated with the optical capsule 55 by being fixed to the surface of the optical capsule 55. With the second magnetic sensor 66 being placed in this way, a space between the coil 84 of the second electromagnet 68 and the optical capsule 55 can be effectively used, thereby making it possible to reduce the size of the device.

The first and second magnetic bodies 81 and 83 that respectively configure the first and second electromagnets 67 and 68, the first magnetic sensor 65, and the second magnetic sensor 66 are placed on one radial line passing through the center of the optical capsule 55, and configure a position detection and control unit 85.

As shown in FIG. 6, the position detection and control units 85 are provided in spaces among the magnetic rotation drivers 64 that are provided in the circumferential direction at an equal distance from one another. Three magnetic rotation drivers 64 are provided at an angle of 120 degree between one another with respect to the center of the optical capsule 55, that is, the center of the regularly-positioned rotation body 53. Three position detection and control units 85 also are provided at an angle of 120 degree between one another with respect to the center of the optical capsule 55. As shown in FIG. 7, this configuration is attained by removing three equally-spaced stator cores, each of which having one tooth, from the conventional three-phase motor having twelve stators and eight poles, and then by placing the position detection and control units 85 in the spaces vacated by the stator cores.

As described above, the first magnetic sensor 65, the second magnetic sensor 66, the first electromagnet 67, the second electromagnet 68, and the permanent magnet 69 are provided at a same position in the circumferential direction, and placed in the spaces among magnetic rotation drivers 64, therefore it is possible to effectively use the space outside the optical capsule 55, and thus saving space.

The stator core 71 that configures the magnetic rotation driver 64, the first magnetic body 81 that configures the first electromagnet 67, the second magnetic body 83 that configures the second electromagnet 68, and the permanent magnet 69 each abut the outer surface of the optical capsule 55. Therefore, when dimensions of the optical capsule 55 are accurately kept, it is possible to determine relative positions of each component with extreme accuracy, thereby enabling a high controlling capability.

FIG. 9 illustrates main portions of the rotational driving device 54 shown in FIG. 4 and the shift controller 14. As shown in FIG. 9, the shift controller 14 includes a position determiner 91 and a conduction controller 92. The position determiner 91 determines a position of the rotation body 53 in the radial and axial directions based on a signal output from the first magnetic sensor 65 and the second magnetic sensor 66. The conduction controller 92 controls conduction amounts of the coil 82 and the coil 84, each of which is provided to the first electromagnet 67 and the second electromagnet 68 respectively, based on a determination result of the position determiner 91. The position determiner 91 and the conduction controller 92 are operated by executing a predetermined program in the CPU of the calculation processor 77 shown in FIG. 8.

The position determiner 91 includes an amplifier (not shown in the drawings) that amplifies an analog output from the first magnetic sensor 65, and an AD converter (ADC) (see FIG. 8). The position determiner 91 determines a radial-direction position of the rotation body 53 based on a digitally converted value of magnetism of the first magnetizer 61 detected by the first magnetic sensor 65. Similarly, an axial-direction position of the rotation body 53 is determined based on a digitally converted value of magnetism of the second magnetizer 62 detected by the second magnetic sensor 66.

The conduction controller 92 compares an actual position of the rotation body 53 determined by the position determiner 91 with a regular position thereof, and calculates an adjustment value for the radial and axial directions in order to correct a displacement of the rotation body 53 with respect to the regular position. As shown in FIG. 8, the adjustment value is transmitted from the calculation processor 77 to a first electromagnet driver 93 and a second electromagnet driver 94 through a D/A converter (DAC) so as to apply an electric current corresponding to the adjustment value to the coil 82 of the first electromagnet 67 and the coil 84 of the second electromagnet 68. With such a feedback control, the rotation body 53 is sustained or maintained in a regular position in the radial and axial directions. Specific examples of a feedback control may include, for example, a PI control, a PID control, and an observer control that includes a compensator in addition to the PI control and the PID control, and the like.

Herein, the first magnetic sensor 65 and the first electromagnet 67 are mutually provided at a same position in the circumferential direction, therefore the position of the rotation body 53 in the radial direction detected by the first magnetic sensor 65 is the same as a position where the first electromagnet 67 applies a radial-direction force to the rotation body 53. Also, the second magnetic sensor 66 and the second electromagnet 68 are mutually provided at a same position in the circumferential direction, therefore a position of the rotation body 53 in the axial direction detected by the second magnetic sensor 66 is the same as a position where the second electromagnet 68 applies an axial-direction force to the rotation body 53. Therefore, it is possible to simplify a calculation process for position control, and to control a position of the rotation body 53 with ease and high accuracy.

Further, in the shift controller 14, a position determination operation by the position determiner 91 and a position control operation by the conduction controller 92 are alternately performed through time sharing. In other words, while the position control operation that conducts the coil 82 of the first electromagnet 67 and the coil 84 of the second electromagnet 68 is performed, the position determination operation based on signals output from the first magnetic sensor 65 and the second magnetic sensor 66 is not performed. By contrast, while the position determination operation is performed, the position control operation is not performed.

Therefore, it is possible to avoid a circumstance where the first magnetic sensor 65 and the second magnetic sensor 66 inaccurately detect magnetism of the first magnetizer 61 and the second magnetizer 62 due to an influence of a magnetic field generated by conduction of the coil 82 of the first electromagnet 67 and the coil 84 of the second electromagnet 68.

When the calculation processor 77 in FIG. 8 detects or expects an increase in viscosity of the liquid 56, the conduction controller 92 increases an electric current flowing in each of the coils 82 and 84 or performs a control to increase a conduction period. Thus, the first and second electromagnets 67 and 68 generate a greater amount of heat, thereby making it possible to promote heating of the liquid 56. In this case, in the second electromagnet 68, a repulsive force of the rotation body 53 to the electromagnet 69 and a repulsive force of the rotation body 53 to the second electromagnet 68 become unbalanced. In the optical shift using a parallel plate, however, no change occurs in the optical shift amount even when the parallel plate 43 shifts in parallel in the optical axis direction. Therefore, as long as the axial-direction position of the rotation body 53 is not widely changed due to an increase in the viscosity of the liquid 56, the above-mentioned control does not cause any problem.

In super-resolution processing performed in the super-resolution processor 24 shown in FIG. 2, it is possible to considerably reduce a calculation cost of a positioning process when an image capturing position of a base frame image is known. For example, when an image capturing element 31 of 1.2 mega pixel is structured in a size of one-third inch, a pixel pitch becomes approximately 3.75 When enlarging the image with a 4×4 magnification with super-resolution processing, a pixel pitch of a newly generated image is 3.75/4=0.93 μm. Therefore, it is desirable to accurately determine the image capturing position in submicron order.

In order to determine an image capturing position of a frame image with high accuracy, first of all, it is necessary to control a position of the optical member 51 with high accuracy. As described above, the position of the optical member 51 is controlled by the first magnetic sensor 65, the second magnetic sensor 66, the first electromagnet 67, and the second electromagnet 68. Further, in order to determine the image capturing position of the frame image with high accuracy, it is necessary to highly accurately detect a rotation position of the rotation body 53 that defines a direction of light shift by the parallel plate 43.

For that, as shown in FIG. 6, the rotational driving device 54 is provided with the origin or original sensor 70 that detects an original position, which is a reference position when the optical member 51 rotates. Based on a signal output from the original sensor 70, a shift position is determined for an optical image captured by the image capturing element 31 in response to a timing signal generated by the driving circuit 33. With this, it is possible to determine an image capturing position of a frame image with high accuracy as well as to reduce a calculation cost of the super-resolution processing.

The origin sensor 70 is configured with a reflection-type photo sensor (photo reflector) and detects a marking (not shown in the drawings) formed on the supporting ring 52 of the optical member 51. The marking may be formed on the surface of the supporting ring 52 by applying a paint in a desired color (for example, white if the supporting ring is black) by use of a printing method or the like. The origin sensor 70 is not limited to the reflection-type photo sensor, and other known sensors, including other types of optical sensors, may be used.

In addition, in order to accurately determine an image capturing position of a frame image, it is necessary to accurately control a driving speed of the optical member 51. For that, first of all, it is necessary to detect a driving speed of the rotation body 53 with high accuracy. Herein, the driving speed of the rotation body 53 is obtained based on a signal output from the first magnetic sensor 65. When the first magnetizer 61 rotates along with the rotation body 53, a magnetic pole (a north pole and a south pole) opposing the first magnetic sensor 65 is alternately switched. The signal output from the first magnetic sensor 65 has a sinusoidal wave shape, one cycle of which corresponds to a period where a pair of a north pole and a south pole on the first magnetizer 61, which is magnetized in polar anisotropic orientation, alternates. Based on the cycle of the output signal, it is possible to obtain the rotation speed of the rotation body 53.

The description above is more specifically described with reference to FIG. 8. The output signal of the first magnetic sensor 65 is binarized in a comparator (CMP) and output as a three-system FG pulse. A pulse interval of the FG pulse is measured by a high speed counter (not shown in the drawing). The calculation processor 77 performs a calculation, in which a known distance between magnetic poles in the first magnetizer 61 is divided by a value measured by the high speed counter, thereby obtaining an actual speed value Vn.

Further, in addition to the above described method that detects a rotation speed, for example, an optical sensor (photo reflector) may be employed so as to detect a marking applied on the optical member 51, the first magnetizer 61, and the like. In this case, when the marking is made in black and white, it is possible to draw the marking with relatively narrow pitch, thereby making it possible to detect a rotation angular speed at a higher sampling rate.

Furthermore, in order to rotate the optical member 51 with a constant speed, herein a PI control (proportional integral control) is performed based on the rotation speed of the optical member 51. Specifically, first, a target speed value Vr is set in response to the circular motion period directed by the period setter 25 (see FIG. 2), and then an error δV (=Vr−Vn), which is a discrepancy between the target speed value Vr and the actual speed value Vn, is calculated. The error δV is then multiplied by an appropriate gain Gp so as to calculate a proportional value (P=Gp×δV). Further, due to an occurrence of speed offset, the error δV is integrated and then multiplied by an appropriate gain Gi so as to calculate an integral value (I=Gi×Σ(δV)). Finally, the speed command value is obtained by adding the above-obtained proportional value (P) and the integral value (I). As described earlier, the speed command value is sent to the pulse width modulator (PWM) so as to output a PWM signal that drives the three-phase driver 74. In this way, the optical member 51 can be rotated with a constant speed with high accuracy.

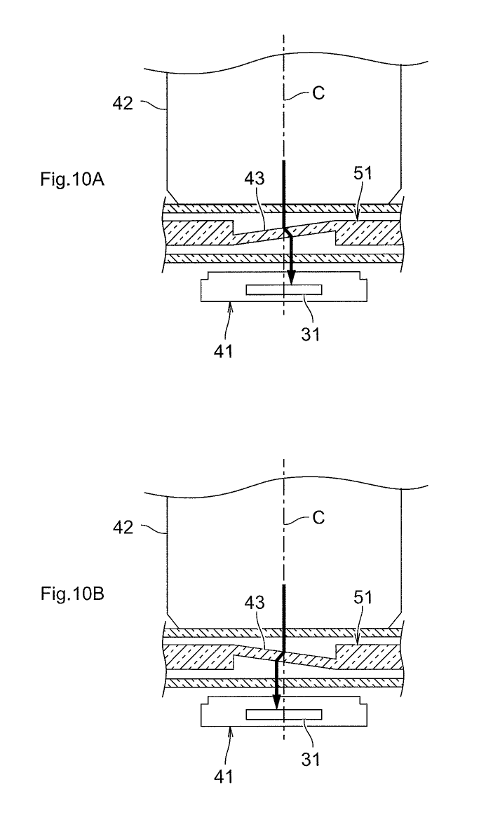

FIGS. 10A and 10B are cross-sectional views showing incidence statuses of light toward the image capturing element 31. FIG. 10A illustrates a state where a light path of the incident light shifts toward the rightmost side. FIG. 10B illustrates a state where the parallel plate 43 is rotated by 180 degrees from the state in FIG. 10A. Incidentally, when the parallel plate 43 is further rotated by 180 degrees from the state in FIG. 10B, the state in FIG. 10A is again attained.

The parallel plate 43 of the optical member 51 inclines with respect to the optical axis C of the lens unit 42 so as to refract the incoming incident light from the lens unit 42. Therefore, the position of the incident light on the light-receiving surface 31 a of the image capturing element 31 changes depending on the rotation position of the parallel plate 43. When the optical member 51 is rotated by the optical shift mechanism 35, the optical image formed on the light-receiving surface 31a of the image capturing element 31 shifts so as to draw a circle at a cycle (circular motion period) corresponding to the rotation speed of the optical member 51. In this way, it is possible to slightly displace the optical image relative to the image capturing element 31.

As descried above, the parallel plate 43 only has a function that shifts the incident light passed through the lens unit 42 in a direction perpendicular to the optical axis C. Further, because relative positions between the lens unit 42 and the image capturing element 31 are fixed, an angle of view on the side of the image capturing element 31 is accordingly determined. As is apparent from the above description, the amount of optical shift remains unchanged regardless of whether the parallel plate 43 displaces parallel to the direction of the optical axis C or to the direction perpendicular to the optical axis C. On the other hand, a change in an angle between the parallel plate 43 and the optical axis C significantly affects the amount of optical shift. In other words, an angle change of the optical member 51 with respect to the optical axis C has a great deal of influence in controlling a displacement of the optical member 51 including the parallel plate 43. Ultimately, the parallel displacements of the optical member 51 in the direction along the optical axis C and in the direction perpendicular to the optical axis C (in the radial direction) are controlled so that the optical member 51 does not abut the internal surface of the optical capsule 55. As described above, herein, the magnetic rotation driver 64 applies magnetism from outside to the optical member 51, and on average the magnetism acts to align a rotation center of the optical member 51 with the optical axis C. Therefore, it is possible to omit the first electromagnet 67 and the first magnetic sensor 65 from the components described above. In this case, however, there is a possibility that the optical member 51 produces small oscillations. When such an oscillation in an image capturing device is undesirable, the first electromagnet 67 and the first magnetic sensor 65 should not be omitted.

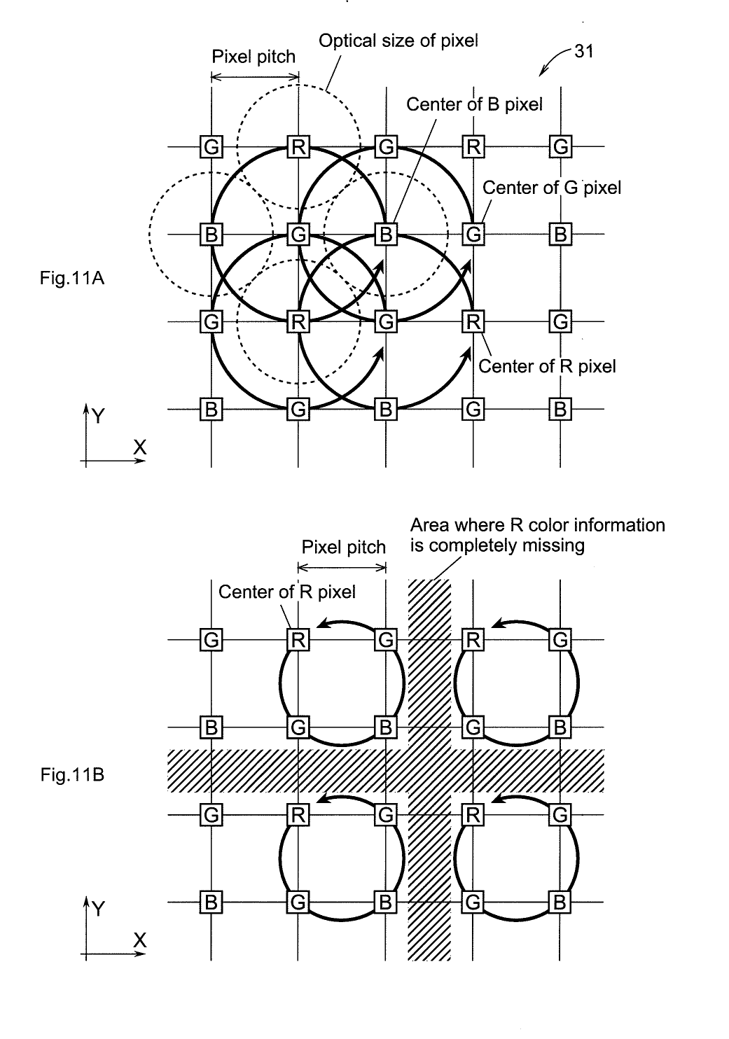

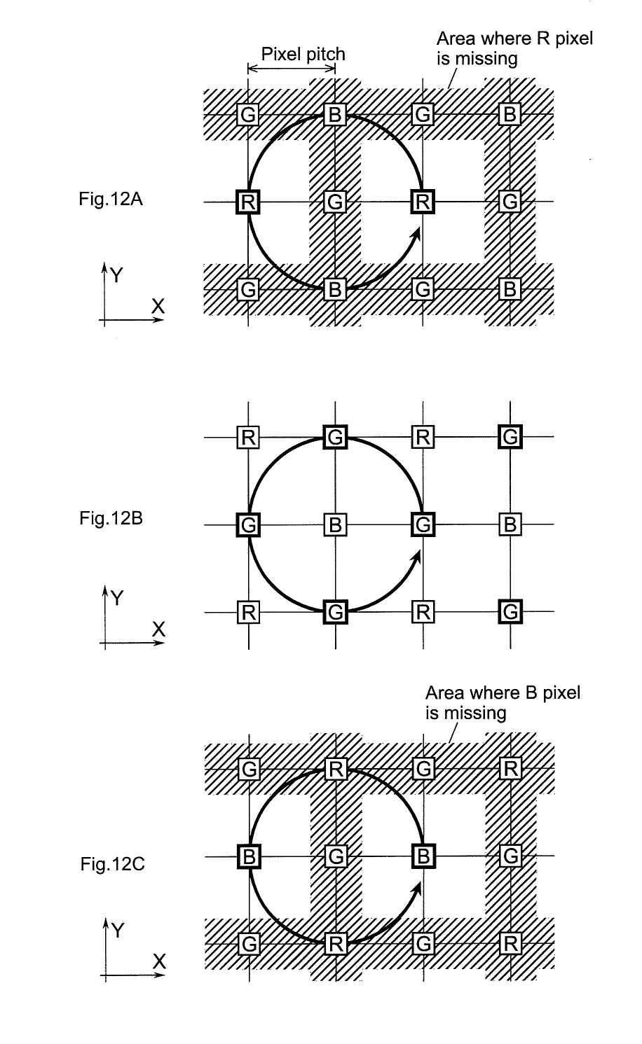

FIGS. 11A to 12C are schematic diagrams illustrating statuses of a relative circular motion of pixels relative to an optical image. The image capturing element 31 is a single-chip image capturing element that has R pixels, B pixels, and G pixels arranged based on the Bayer filter mosaic, R pixels receiving R (Red) components from the incoming light; B pixels receiving B (Blue) components from the incoming light; and G pixels receiving G (Green) components from the incident light. In the Bayer filter mosaic, 50% of the total pixels are made of G pixels arranged in a checkered flag manner. R pixels and B pixels, each of which occupies 25% of the total pixels, are dispersedly provided in the areas where G pixels are not disposed. Hereinafter, X-axis refers to a main scanning direction, and Y-axis refers to a vertical scanning direction.

As shown in FIG. 10, an optical image displaces with respect to a pixel of the fixed image capturing element 31. In the description hereinafter, however, as a matter of convenience, a relative displacement of a pixel with respect to an optical image is shown as a displacement of a pixel with respect to a still optical image. Further, each pixel receives a range of light shown as substantially an optical size. However, in the description hereinafter, as a matter of convenience, only a central position of each pixel is shown.

Herein, as shown in FIG. 11B, when a diameter of a circular motion is set to be √2 times of the length of a pixel pitch, for example, there is an area where color information of R is completely missing due to being out of the displacement area of R pixels. Similarly, there is an area where color information of B pixels is completely missing due to being out of the displacement area of B pixels. Incidentally, as in the conventional technology, when a diameter of a circular motion is set to be √2/2 times of the length of a pixel pitch, there is even a larger area where R color information is completely missing. Therefore, it is impossible to re-create a high-resolution image even when super-resolution processing is performed on a low-resolution image captured by a common single-chip color image sensor having a Bayer filter mosaic.

By contrast, when a diameter of a circular motion is set to be two times of the length of a pixel pitch, as shown in FIG. 11A, it is possible to move R pixels and B pixels to an area where neither R pixels nor B pixels exist as shown in FIGS. 12A and 12C. In this way, image capturing positions can be equally dispersed, and super-resolution processing can produce a high-resolution image with higher quality. Further, as shown in FIG. 12B, in addition to being originally provided with a large number (50% of total pixels), G pixels are provided in a checkered flag manner so as to scan in the surrounding areas, thereby making it possible to fully sample an optical image.

By contrast, when a diameter of a circular motion is set to be more than two times of the length of a pixel pitch, a band-shaped area, where R pixels and B pixels cannot be captured, is not generated. However, when a diameter of a circular motion is increased while maintaining a constant angular velocity of a circular motion, a displacement speed of an optical image (that is, circumferential velocity) is increased. In this case, when a same image capturing period (period of storing charge in the image capturing element 31) is given, an optical image is displaced a farther distance so as to increase an integral effect. In other words, an image blurring (the same situation as what is called a motion blurring) occurs, therefore a high frequency component is lost by pixel integration, which is a factor that suppresses the effectiveness of super-resolution processing.

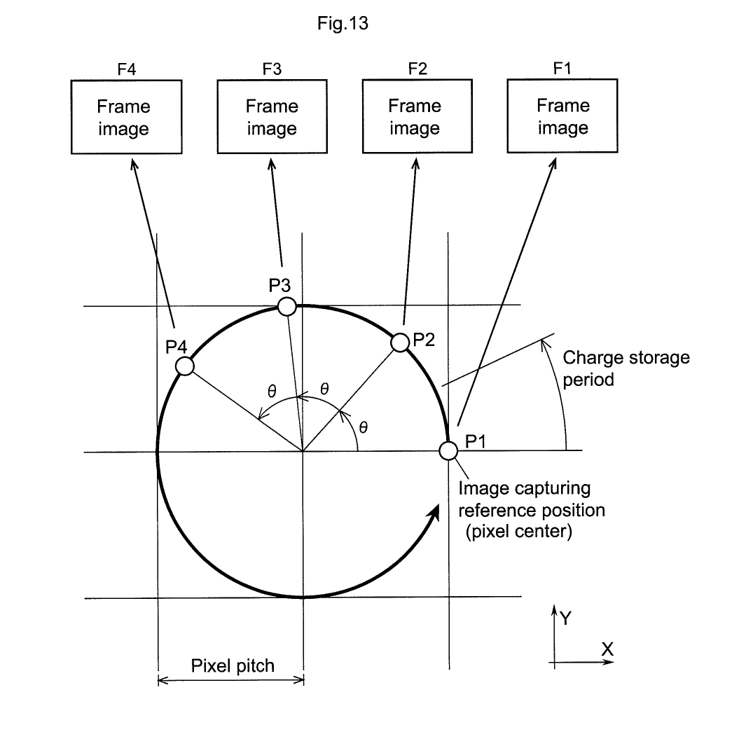

An image capturing (sampling) is described next. FIG. 13 is a schematic diagram illustrating a status of an image capturing and images generated from the image capturing.

Herein, images are captured while a circular motion of a pixel relative to an optical image is continuously performed in a direction at a certain speed so as to sequentially generate frame images F1, F2 . . . , the image capturing position of which are slightly displaced. Shown image capturing reference positions P1, P2 . . . illustrate timings of image capturing, at each of which a frame image is generated. In particular, herein, a center position of a pixel at the time of starting an image capturing is shown as an image capturing reference position. Charge storage is started at each image capturing reference position and completed before the following image capturing reference position, and thereafter a pixel signal is output.

A rotation speed of the circular motion is maintained steady by the above-described PI control. A reference position of a rotation position of the parallel plate 43 (see FIG. 4) is controlled by the origin sensor 70 (see FIG. 6). An influence on shift width (shift position) generated associated with the change in an inclination angle of the parallel plate 43 is suppressed to be small. Therefore, an image capturing position of a frame image captured at each timing is determined with extremely high accuracy.

Information about the image capturing position, as shown in FIG. 2, is sequentially generated in the shift controller 14 (the calculation processor 77 shown in FIG. 8, more specifically) based on the output from the first magnetic sensor 65 and the origin sensor 70. The information about the image capturing position is transmitted from the image capturing device 1 to the image processing device 2, and then is stored in the memory 23, being associated with a frame-by-frame image data output from the image capturing portion 11. The information about the image capturing position is further referenced by the super-resolution processor 24 during the super-resolution processing, which simplifies the positioning process.

In order to obtain a proper high-resolution image by the super-resolution processing, it is desirable that all pixels be uniformly displaced. It is not preferable that charge storage be conducted at different timings at each pixel line. Therefore, a global shutter system is employed in this example so as to release a shutter of all pixels at a single time.

The quality of a high-resolution image obtained by the super-resolution processing can be improved by capturing (sampling) a large number of images at one circular motion performed by a pixel. In particular, herein a circular motion period is set to be non-integral multiple of an image capturing period. With this, it is possible to capture an image at many different positions by repeating circular motions, thus it is possible to generate a large number of images having slightly different image capturing positions so as to improve the quality of the high-resolution images obtained by the super-resolution processing. By contrast, when a circular motion period is set to be integral multiple of the image capturing period, no change is made to the image capturing reference positions even when circular motions are repeated, therefore the number of captured images is limited to the number of the image capturing reference positions that can be accommodated by one circular motion.

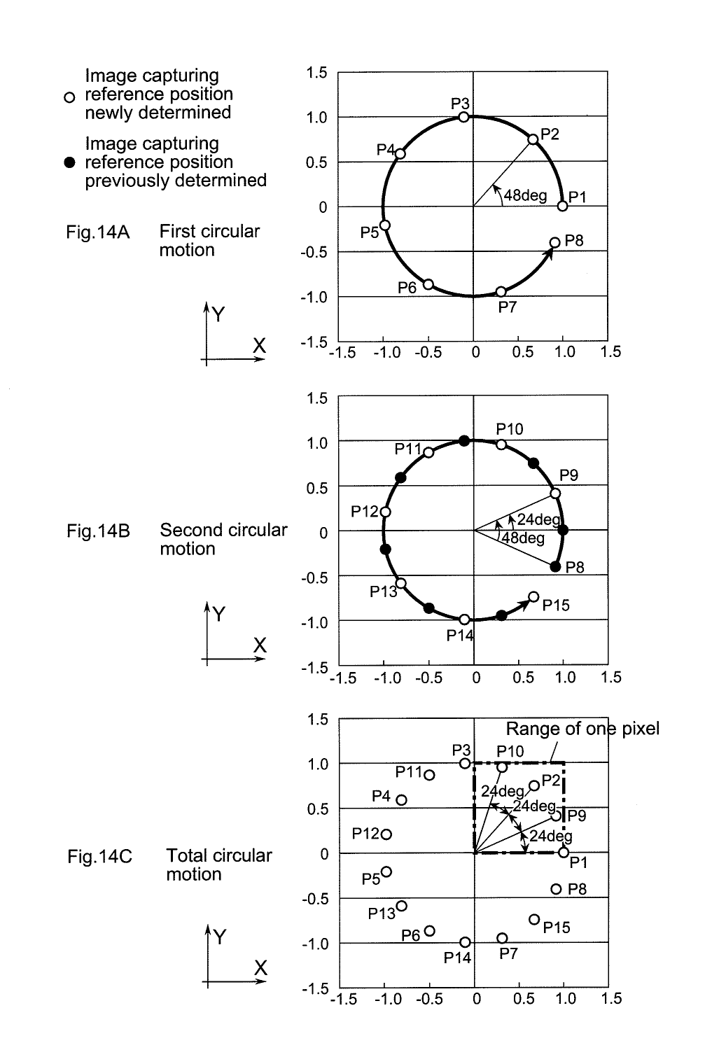

Hereinafter, an example of an image capturing reference position is described with a specific ratio of a circular motion period to an image capturing period. FIGS. 14A to 14C are schematic diagrams illustrating statuses of an image capturing reference position in one example of the ratio of the circular motion period to the image capturing period. In the illustration in FIGS. 14A to 14C, a pixel pitch is shown as one.

In this example, a circular motion period is set to be 7.5 times of the duration of an image capturing period. Herein, when an image capturing period is set to be 30 ms (about 30 frames per second), for example, the circular motion period is 225 ms (=30 ms×7.5). In this case, an image capturing reference position returns to an original position after two circular motions; and an image capturing (sampling) is performed 15 times during the two circular motions. Each image capturing reference position is separated with a relative angle of 48 degrees (=360 degrees/7.5) from another image capturing reference position.

As shown in FIG. 14A, images are captured at image capturing reference positions P1 to P8 during the first circular motion. During the second circular motion, as shown in FIG. 14B, images are captured at image capturing reference positions P9 to P15, which correspond to middle points between neighboring two image capturing reference positions (P1 and P2, for example) in the first circular motion. In combination of the first and second circular motions, as shown in FIG. 14C, each image capturing reference position P I to P15 is separated by a relative angle of 24 degrees from another image capturing reference position.

Herein, it is possible to select one out of two processing modes, the first processing mode performing super-resolution processing based on eight images obtained by the image capturing at the image capturing reference positions P1 to P8 of the first circular motion; and the second processing mode performing super-resolution processing based on 15 images obtained by the image capturing at the image capturing reference positions P1 to P15 combining the first and second circular motions.

In the first processing mode, two image capturing reference positions, each of which has a different position in both X and Y axis directions, are provided within the range of an original one pixel. Therefore, it is possible to obtain a high-resolution image having substantially two times of the original resolution of the image capturing element 31 in each X and Y axis direction. On the other hand, in the second processing mode, four image capturing reference positions, each of which has a different position in both of the X and Y axis directions, are provided within the range of an original one pixel. Therefore, it is possible to obtain a high-resolution image having substantially four times of the original resolution of the image capturing element 31 in each of the X and Y axis direction.

In particular, in the second processing mode, each of the image capturing reference positions P9 to P15 set by the second circular motion becomes a middle point of neighboring two of image capturing reference positions P1 to P8 set by the second circular motion. Therefore, the image capturing reference positions are evenly distributed without being disproportionate, thereby making it possible to generate an image that has high adaptability to super-resolution processing.

Further, it is also possible to perform super-resolution processing in the image capturing device 1 while the image capturing device 1 is capturing an image. In this case, in the second processing mode, super-resolution processing may be performed every time when 15 images are obtained by two circular motions.

On the other hand, in the first processing mode, super-resolution processing may be performed every time eight images are obtained by sequentially shifting the image capturing reference positions. Specifically, eight images obtained by the image capturing at the image capturing reference positions P1 to P8 are used for a first super-resolution processing. Eight images obtained by the image capturing at the image capturing reference positions P9 to P15 and P1 are used for a second super-resolution processing. Subsequently, the image capturing reference positions are displaced one by one, such as the image capturing reference positions P2 to P9 for a third processing; and the image capturing reference positions P10 to PI5 and P1 to P2 for a fourth processing.

As described above, two processing modes can be provided herein. Both processing modes do not require changing a circular motion period (rotation speed of the optical shift mechanism 35) and an image capturing period, thereby providing easy control.

The first image used for the super-resolution processing in each mode is not limited to the image obtained at the image capturing reference position P1, which is the original position. In the first processing mode, eight images captured during a circular motion starting from an arbitrary position may be used for the super-resolution processing. In the second processing mode, 15 images captured during two circular motions starting from an arbitrary position may be used for the super-resolution processing.

The above-described processing can be employed for super-resolution processing using frame images stored in the memory 23 of the image processing device 2, as shown in FIG. 3. The above-described processing is further applicable to super-resolution processing that is performed while the image capturing device 1 is capturing an image. Especially in the latter case, it is not necessary to return a starting position of an image capturing to the image capturing reference position P I in conjunction with switching of the processing modes, thereby making it possible to immediately generate high-resolution images with different resolutions by switching the processing modes.

As shown in FIG. 2, an image capturing period is directed by a user by use of the input portion 26 of the image processing device 2. A circular motion period is set by the period setter 25 based on the directed image capturing period. A command signal regarding the set circular motion period is transmitted to the image capturing device 1. The shift controller 14 of the image capturing device 1 operates the optical shift mechanism 35 at a rotation speed corresponding to the set circular motion period, based on the command signal regarding the circular motion period obtained from the image processing device 2.

Further, the user can designate a processing mode (the first processing mode or the second processing mode). As shown in FIG. 3, when super-resolution processing is performed using frame images stored in the memory 23 of the image processing device 2, a reference image as well as a processing mode is designated by the user. Thus, the super-resolution processing is performed by loading an appropriate number of frame images according to the above-designated processing mode, based on the designated frame image as a reference image.

Furthermore, the above-described circular motion period can be changed as needed. For example, by setting the circular motion period to be 7.2 times of the duration of the image capturing period, an image capturing reference position returns to the original position after five circular motions, therefore it is possible to perform image capturing (sampling) for 36 times during the five circular motions. In this case, each image reference position is separated by a relative angle of 50 degrees (=360 degrees/7.2) from another image capturing reference position.

### Second Embodiment

The first embodiment describes a configuration where a parallel plate is encapsulated with a liquid so that the parallel plate magnetically floats in the liquid. The configuration is further provided with a heater to heat the liquid, thereby making it possible to always provide a stable optical shift amount. When an optical element such as a parallel plate is enclosed in a capsule along with a liquid, in reality, it is difficult to seal the capsule without including any air inside thereof Even when the capsule is manufactured with no air included inside at the time of manufacturing, since the material for a capsule is limited to a transparent resin or the like, volume of the liquid repeatedly changes in a long-term use due to changes in ambient temperature, which may lead to a phenomenon where the outside air passes through the capsule and enters inside thereof Alternatively, it is also possible to purposefully introduce air into the capsule in advance at the time of manufacturing so that the capsule is not damaged when the liquid is frozen.

However, since a parallel plate, which performs a pixel shift, is provided to a rotation body in a state of being inclined with respect to the optical axis, the rotation body has an uneven portion. When the air that is present in the capsule enters into the uneven portion, inclination angle of the parallel plate with respect to the optical axis is likely to deviate from a desired angle due to buoyancy. Such a circumstance is undesirable because it decreases accuracy of an optical shift amount, and also enormously increases a computation cost for a positioning process. In a case where the air is attached to a surface of a parallel plate, a gas bubble may reflect on an image; and an incident light path (optical path) may be changed at the portion having the gas bubble, thus deteriorating image quality.

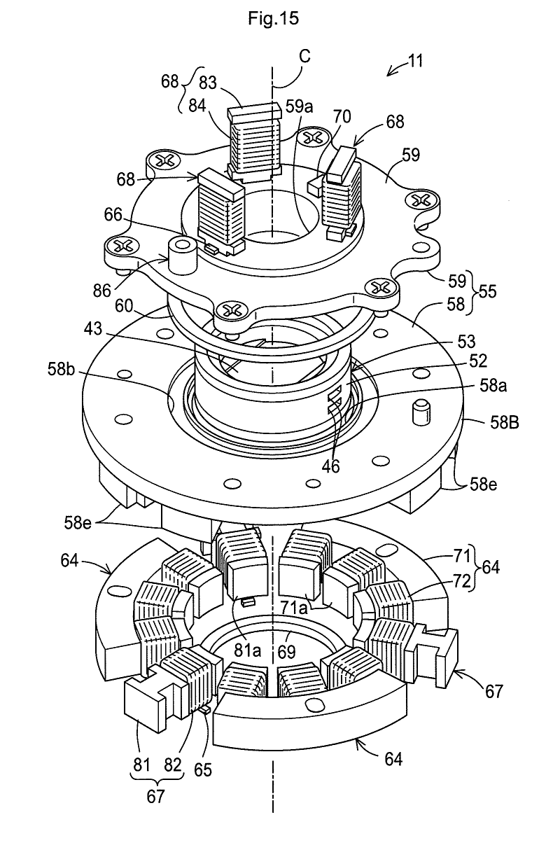

FIG. 15 is an exploded perspective view of an image capturing portion according to the second embodiment of the present invention and also an exploded perspective view of the image capturing portion 11 shown in FIG. 4. Hereinafter, characteristic configurations of the second embodiment are descried with reference to FIG. 15 along with FIG. 4. Other aspects of the configurations are the same as those in the first embodiment, thus illustration thereof is omitted.

In the second embodiment, a gas 57 mixed in the liquid 56 is encapsulated in the optical capsule 55. It is preferable that none of the gas 57 exist in the optical capsule 55 from a viewpoint of a position control of the rotation body 53. In a manufacturing process, however, it is difficult to assemble the optical capsule 55 while completely preventing the air from being included inside thereof. In addition, even when anti-freeze solution is used for the liquid 56, it is possible that the liquid 56 freezes under an extremely severe condition. Thus, in order to prevent the optical capsule 55 from being damaged due to a volume expansion of the frozen liquid 56, it is preferable, in terms of quality management, to introduce the air into the optical capsule 55 with a certain proportion as long as the volume expansion of the frozen liquid 56 is tolerable.

The optical capsule 55 has a size which allows forming gaps of a predetermined size between the optical capsule 55 and the supporting ring 52 in both the radial and axial directions so as to form a space that retains the gas 57. This structure enables the rotational driving device 54 to properly control the position of the rotation body 53 so that the rotation body 53 is immersed in the liquid 56 in a floating state, in other words, the rotation body 53 does not touch the gas 57 existing in the optical capsule 55. Herein, an outer annular space Sb of a sealed space S formed by the optical capsule 55 acts as a gas retainer to retain the gas 57.

The gas 57 may enter into the optical capsule 55 not only at the time of manufacturing but also after sealing thereof In a long term of use, water in the liquid 56 permeates through the optical capsule 55 and leaks outside, and the gas 57 permeates through the optical capsule 55 and flows inside as a result. Thus, the amount of liquid in the capsule decreases. The amount of permeated water depends on types and thickness of materials of the optical capsule 55 and on methods for sealing the optical capsule 55, thus it is necessary to measure the amount for each case. The amount of the permeated water can be obtained by multiplying an amount of permeated water per unit time with time in use.

The size of the optical capsule 55 is determined based on the size of the supporting ring 52 so that the outer annular space Sb of the sealed space S can act as a gas retainer in a state where the gas intentionally introduced during the manufacturing process exists along with the gas mixed in due to reduction of water by the water permeation, as described above.

FIGS. 16A and 16B show details of the rotation body 53 shown in FIG. 4. FIG. 16A is a plan view of the rotation body 53, and FIG. 16B is a cross-sectional view of the rotation body 53 taken along the line B-B in FIG. 16A. In FIG. 16B, the gas 57 is shown under an assumption that the rotation body 53 is in the liquid 56. As shown in FIGS. 16A and 16B, the optical member 51 is provided at the center thereof with a parallel plate 43 and bases 44. The parallel plate 43 is inclined at a predetermined angle with respect to the optical axis C and has a band shape. The bases 44 have the same thickness that is thicker than the parallel plate 43, and are placed on the same level on both sides of the parallel plate 43. One surface of the parallel plate 43 in the axial direction continues to one of the bases 44, and the other surface of the parallel plate 43 in the axial direction continues to the other base 44. Therefore, the parallel plate 43 is provided so as to be inclined at a predetermined angle with respect to the bases 44.

With the optical member 51 being configured as described above, the parallel plate 43 can be provided so as to be inclined at a predetermined angle with respect to the optical axis C by merely installing the optical member 51 in such a way that the bases 44 are parallel to the supporting ring 52 whose position is controlled in the direction perpendicular to the optical axis C. Thus, it is possible to assemble the rotation body 53 with high accuracy. Further, although it is possible that an uneven surface exists on one surface of a connecting portion between the parallel plate 43 and the bases 44, grooves 45 each having a flat bottom surface are provided to each base 44 on the surface having the uneven surface. The grooves 45 are formed so as to reach a peripheral edge of the optical member 51, that is, a connecting portion between the optical member 51 and the supporting ring 52, thereby eliminating the uneven surfaces at the connecting portion between the parallel plate 43 and the bases 44.

The supporting ring 52 has four through holes 46 (gas exhaust paths). One end of each through hole 46 opens to the internal peripheral surface, and the other end thereof opens to the outer peripheral surface. Two through holes 46 are each placed in a radial fashion so as to open to the end surface of the groove 45 provided to the bases 44 of the optical member 51. The remaining two through holes 46 are each placed in a radial fashion so as to be parallel to the first two through holes 46 and to have an opening along the opposite surface of the optical member 51.

As shown in FIG. 16B, the rotation body 53 has an H-shaped cross section, and is provided on both sides thereof in the axial direction with concave portions 53a and 53b. When the image capturing device 1 starts operating or is reversed in the direction of the optical axis C during an operation, the gas 57 may exist inside either one of the concave portion 53a and the concave portion 53b, which is positioned on the lower side of the rotation body 53 (the concave portion 53a in FIG. 16B). Further, when the rotation body 53 rotates, the liquid 56 generates a rotating flow in the same direction as the rotation direction of the rotation body 53. The closer to the surface of the rotation body 53, the faster the rotating flow is because of fluid resistance and viscosity of the liquid 56, thus the liquid 56 moves toward the outer periphery side due to the centrifugal force. Therefore, a swirling flow is generated inside the optical capsule 55 in a manner where a flow direction relative to the fixed rotation body 53 is a direction shown by the arrows in FIG. 16A.

Furthermore, with the through holes 46 being provided to the supporting ring 52, the gas 57 existing in the lower concave portion 53a follows the flow of the liquid 56 moving toward the outer periphery side along the lower surface of the optical member 51, and then is exhausted from the opening on the inner peripheral surface of the supporting ring 52 to the outer periphery side thereof via the through holes 46. The centrifugal force increases in accordance with increase in the rotation speed of the rotation body 53, thus the liquid 56 flows faster in the through holes 46, thereby more easily exhausting the gas 57.

After being exhausted to the outer periphery side of the supporting ring 52, the gas 57 is moved upward by buoyancy and stays in an upper portion of the outer annular space Sb (see FIG. 4) in a state where the rotation body 53 is not exposed to the gas 57. Thus, the rotation body 53 is prevented from being inclined by buoyancy of the gas 57, thereby a repeatability and reproducibility of an optical shift amount is ensured. In addition, the gas 57 is prevented from being reflected on an image as a gas bubble and deteriorating image quality.

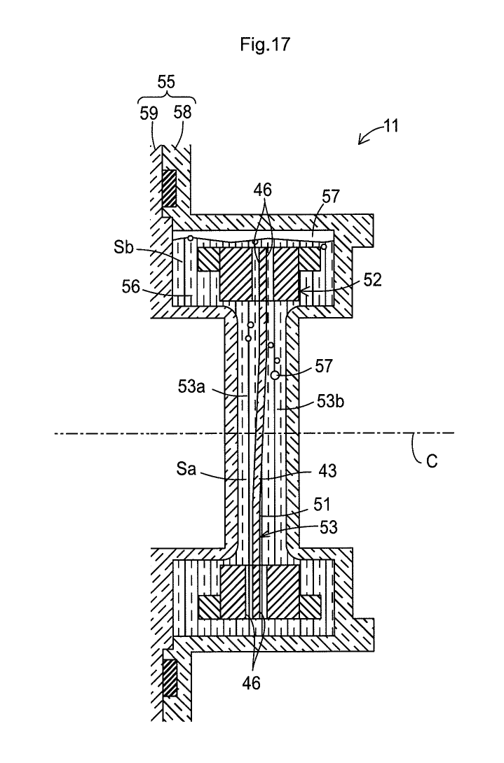

FIG. 17 is a schematic diagram illustrating a posterior posture-change status of the image capturing portion 11 shown in FIG. 4. As shown in FIG. 17, when the image capturing portion 11 changes a posture thereof and the optical capsule 55 is placed so that the optical axis C becomes substantially horizontal, the gas 57 in the concave portions 53a and 53b of the rotation body 53 is exhausted to the outer periphery side of the supporting ring 52 via the through holes 46, or along the inner peripheral surface and the surface on the optical axis C side of the supporting ring 52. Thereafter, the gas 57 is retained in the upper portion of the outer annular space Sb in a state where the rotation body 53 is not exposed to the gas 57. Therefore, even when the image capturing portion 11 changes a posture thereof, the rotation body 53 is prevented from being inclined by buoyancy of the gas 57, thus a repeatability and reproducibility of an optical shift amount is ensured. In addition, the gas 57 is prevented from being reflected on an image a gas bubble and deteriorating image quality.

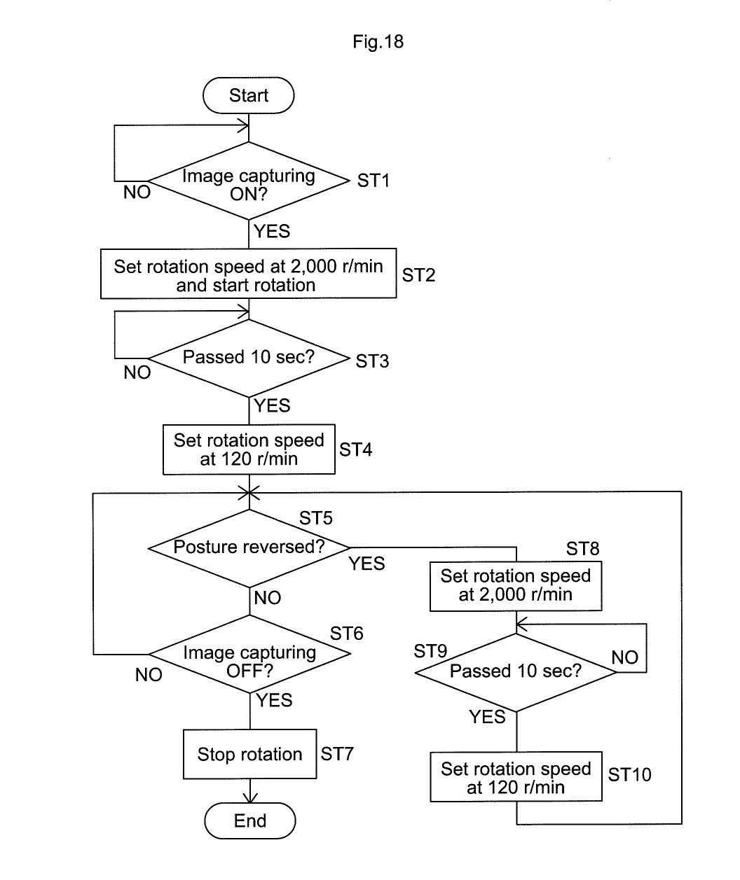

FIG. 18 is a flow chart illustrating processing steps of controlling a rotational driving by a calculation processor 77 shown in FIG. 8. The calculation processor 77 starts controlling the rotational driving as shown in FIG. 8 when the power is turned on. Hereinafter, an operation that exhausts the gas 57 from the central portion Sa (See FIG. 4) of the optical capsule is described with reference to FIG. 18 along with FIGS. 4, 8, and 17. In the description hereinafter, it is assumed that the switch 80 in FIG. 8 is switched by the calculation processor 77, and the internal logic 76 is connected to a neutral point side of the coil 72. A posture detector 86 shown in FIG. 4 detects a posture of the image capturing device 1. The posture detector 86 is, for example, is movably provided in the axial direction of the optical capsule 55, and includes an movable portion 87 having a permanent magnet, and a third magnetic sensor 88 made of a Hall element that detects a magnetic field of the permanent magnet, which changes as the movable portion 87 is displaced.

The posture detector 86 is not limited to a configuration including the movable portion 87 having the permanent magnet and the third magnetic sensor 88. As long as it can detect the inclination angle of an axis line (optical axis C) of the optical capsule 55 with respect to the horizontal surface, the posture detector 86 may employ, for example, an optical sensor (“RPI-1040” manufactured by Rohm, for example) that detects the direction of gravity based on an ON/OFF state of a phototransistor placed in an appropriate place according to shifting of a shaded ball. The calculation processor 77 determines whether or not an image capturing ON signal is input to instruct to start an image capturing (step ST1). When the image capturing ON signal is not input (No), the determination process in step ST1 is repeated. When the image capturing ON signal is input in step ST1 (Yes), the calculation processor 77 activates a counter, sets the rotation speed of the rotation body 53 at a predetermined startup rotation speed (2,000 r/min, in this example) that is fast enough to exhaust the gas 57 existing in the concave portions 53a and 53b outside the supporting ring 52, and then starts to rotationally drive the rotation body 53 (step ST2).

Thereafter, the calculation processor 77 determines whether or not the counter activated in step ST2 has passed a predetermined duration (10 sec, in this example) set for the startup rotation speed (step ST3). When it is determined that the predetermined duration has not passed (No), the determination process in step ST3 is repeated. On the other hand, when it is determined that 10 sec has passed in step ST3 (Yes), the calculation processor 77 sets the rotation speed of the rotation body at a rotation speed (120 r/min, in this example) that corresponds to a circular motion period determined by the period setter 25 (see FIG. 2), and continues to rotationally drive the rotation body 53 (step ST4). As described above, prior to an image capturing, the rotation body 53 is rotated at a rotation speed that is fast enough to exhaust the gas 57 outside the supporting ring 52 in order to prevent an image quality from being deteriorated by the gas 57 staying in a light path. After such a period, an image capturing is continued while the rotation body 53 is rotated at a rotation speed of 120 r/min, for example.

Subsequently, the calculation processor 77 determines whether or not an inclination of the axis line of the optical capsule 55 with respect to the horizontal direction is reversed, in other words, whether or not the posture of the capsule 55 is reversed in order to move the gas 57 to the opposite side in the optical axis C direction, based on a detection result of the posture detector 86 (see FIG. 4) described in the second embodiment (step ST5).

When it is determined that the posture has not been reversed in step ST5 (No), the calculation processor 77 determines whether or not an image capturing OFF signal is input to instruct to stop image capturing, while continuing to rotationally drive the rotation body 53 at a rotation speed of 120 r/min (step ST6). When it is determined that the image capturing OFF signal has not been input in step ST6 (No), the calculation processor 77 repeats the determination processes of steps ST5 and ST6. On the other hand, when it is determined that the image capturing OFF signal has been input in step ST6 (Yes), the calculation processor 77 sets the rotation speed of the rotation body 53 at a rotation speed of 0 r/min, and stops the rotational driving (step ST7).

On the other hand, when it is determined that the posture has been reversed in step ST5 (Yes), the calculation processor 77 activates the counter, and sets the rotation speed of the rotation body 53 at a predetermined rotation speed for a reverse operation (2,000 r/min, in this example) that is fast enough to exhaust the gas 57 existing in the concave portions 53a and 53b to the outside of the supporting ring 52, and continues to rotationally drive the rotation body 53 (step ST8).

Thereafter, the calculation processor 77 determines whether or not the counter activated in step ST8 has passed a predetermined duration (10 sec, in this example) set for the rotation speed for the reverse operation (step ST9). When it is determined that the predetermined duration has not passed (No), the determination process in step ST9 is repeated. On the other hand, when it is determined that 10 sec has passed in step ST9 (Yes), the calculation processor 77 sets the rotation speed of the rotation body 53 at a rotation speed (120 r/min, in this example) that corresponds to a circular motion period decided by the period setter 25 (see FIG. 2), continues to rotationally drive the rotation body 53 (step ST10), and then goes back to the process in step ST5.

As described above, in steps ST2 and ST3, the calculation processor 77 sets the rotation speed of the rotation body 53, which has been just activated, at a predetermined startup rotation speed for a certain duration. Accordingly, during this period, the gas 57 in the concave portions 53a and 53b of the rotation body 53 or the gas 57 attached to the surface of the optical member 51 can be exhausted outside the supporting ring 52 and thus removed from the rotation body 53, even when the gas 57 enters into the concave potions 53a and 53b or attached to the surface of the optical member 51 while the image capturing device 1 is not operating. Thereby, it is possible to appropriately keep the buoyancy balance of the rotation body 53, and also to prevent the gas 57 from being reflected on an image as a gas bubble.

When a determination result in step ST5 is Yes, the calculation processor 77 sets the rotation speed of the rotation body 53 at a predetermined rotation speed for a reverse operation for a certain duration in steps ST8 and ST9. Accordingly, during this period, the gas 57 in the concave portions 53a and 53b of the rotation body 53 or the gas 57 attached to the surface of the optical member 51 can be exhausted outside the supporting ring 52 and thus removed from the rotation body 53, even when the gas 57 has entered into the concave potions 53a and 53b or attached to the surface of the optical member 51 at the time of the posture-reverse operation of the optical capsule 55. Thereby, it is possible to appropriately keep the buoyancy balance of the rotation body 53, and also to prevent the gas 57 from being reflected on an image as a gas bubble. As described above, in the second embodiment, the gas 57 is exhausted outside the light path by the centrifugal force generated by the rotation of the rotation body 53. Accordingly, the lower the viscosity of the liquid 56 is, the more efficiently a gas bubble is exhausted. Therefore, when the above-described gas exhaust operation is performed, the liquid 56 may be heated in a way described in the first embodiment. In other words, when the rotation body 53 is rotated so as to exhaust the gas 57 outside the concave portions 53a and 53b (see FIG. 16) via the gas exhaust paths (through holes 46), the liquid 56 may be heated by use of a heater (the magnetic rotation driver 64 shown in FIG. 6, for example). Similarly, also in third to fifth embodiments described hereafter, the gas 57 can be efficiently exhausted in combination with the first embodiment. Furthermore, when the gas 57 enters into the concave portions 53a and 53b of the rotation body 53, the balance of the rotation body 53 is lost due to buoyancy. To address the circumstance, the calculation processor 77 in FIG. 8 attempts to suppress vibrations of the rotation body 53 by PID control, for example, as described in the first embodiment. Accordingly, a change occurs in control outputs to the electromagnet driver 94. In general, temporal fluctuation in outputs of the electromagnet driver 94 increases when a control is performed to inhibit a displacement (shake) of the rotation body 53 in the optical axis C direction. Since the control outputs to drive the electromagnet driver 94 are output by the calculation processor 77, the CPU, for example, provided to the calculation processor 77 can detect the fluctuation in the control outputs. Thereby, the CPU determines that the gas 57 has entered into the light path. In this case, the above-described operation that exhausts the gas 57 may be performed.

### Third Embodiment

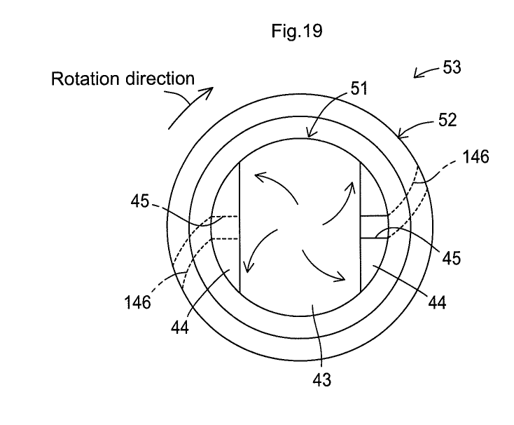

FIG. 19 is a schematic plan view of a rotation body 53 according to a third embodiment in the present invention. Herein, only points different from the second embodiment are illustrated. Configuration components similar to the second embodiment are provided with the same numerical references, and illustration thereof is omitted. The same applies to following embodiments.

In the second embodiment, as shown in FIG. 16A, the through holes 46 are formed in the radial direction of the rotation body 53. In the rotation body 53 of the present embodiment, as shown in FIG. 19, through holes 146 (gas exhaust paths) are provided in such a way that the through holes 146 are more inclined toward the direction opposite to the rotation direction from the radial direction of the rotation body 53 as the through holes 146 get closer to the outer side in the radial direction.

As described above, in accordance with the rotation of the rotation body 53, the liquid 56 generates a swirling flow that moves to the outer periphery side due to the centrifugal force while rotating in the same direction as the rotation body. With the through holes 146 configured as described above, the extending direction of the through holes 146 becomes similar to the flow direction of the liquid 56, thus the liquid 56 is more easily introduced into the through holes 146. In addition, a rotation force of the rotation body 53 acts to push the liquid 56 in the through holes 146 toward the outer periphery side, thus the amount of the liquid 56 flowing inside the through holes 146 increases even when a cross-section thereof is not changed. Consequently, the gas 57 having entered in either one of the concave portions 53a and 53b, which is on the lower side of the rotation body 53, can be more easily exhausted outside the concave portion 53a or 53b. Therefore, it is possible to shorten the duration of the startup rotation speed and the rotation speed for a reverse operation, and to start to rotate the rotation body 53 at a designated rotation speed at an earlier timing.

### Fourth Embodiment

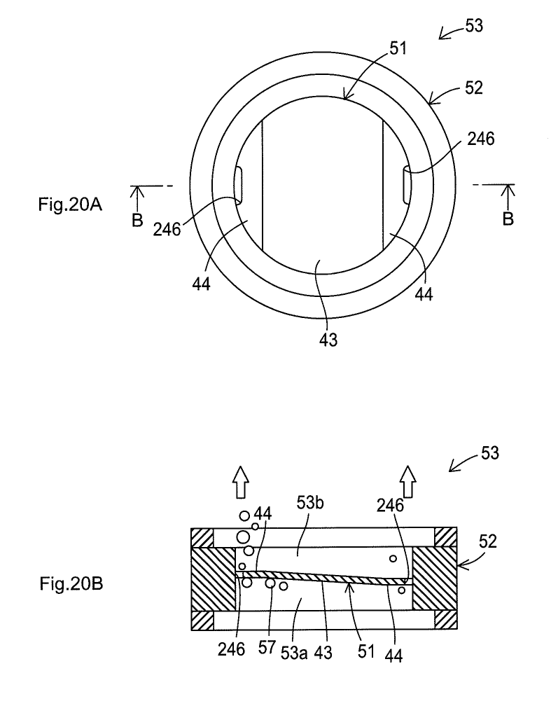

FIGS. 20A and 20B illustrate details of a rotation body 53 according to a fourth embodiment of the present invention. FIG. 20A is a plan view of the rotation body 53, and FIG. 20B is a cross-sectional view of the rotation body 53 taken along the line B-B in FIG. 20A. In the second embodiment, as shown in FIGS. 16A and 16B, the through holes 46 are formed so as to be open to the inner and outer peripheral surfaces of the supporting ring 52. In the present embodiment, however, as shown in FIGS. 20A and 20B, through holes 246 (gas exhaust paths) are provided to the optical member 51 so as to communicate between the concave portions 53a and 53b of the rotation body 53. A total of two through holes 246, each of which is provided to each of the bases 44 of the optical member 51, are provided at the outer edge of the optical member 51 so as to fit along the inner peripheral surface of the supporting ring 52.

With the through holes 246 being provided as described above, in a case where the rotation body 53 is rotationally driven with the axis thereof being vertical, as shown in FIG. 20B, the gas 57 in the lower concave portion 53b, which is likely to affect the optical shift amount and image quality, is gathered at the outer edge of the optical member 51 riding the swirling flow associated with the rotation of the rotation body 53. Then, the gas 57 flows into the through holes 246 due to buoyancy when the through holes 246 that is rotating faster passes above, and moves into the upper concave portion 53a, from which the gas 57 can be easily exhausted. Thereafter, the gas 57 is moved upward by buoyancy, and is retained in the above-described outer annular space Sb (see FIG. 4). Similarly, even when the axis of the rotation body 53 is inclined, the gas 57 in the lower concave portion 53b is moved to the upper concave portion 53a via the through holes 246 by buoyancy, and then is retained in the outer annular space Sb.

On the other hand, in a case where the rotation body 53 is rotationally driven with the axis thereof being horizontal, the gas 57 in the concave portions 53a and 53b positioned on right and left sides (two sides in the axial direction) is moved upward by buoyancy. Then, the gas 57 is exhausted outside along the inner peripheral surface of the supporting ring 52 by the swirling flow generated along the surface of the rotation body 53 without passing through the through holes 246.

The through holes 246 are formed on the optical member 51 that has relatively low specific weight, and are provided in the thickness direction of the optical member 51. Therefore, the extent of the through holes 246 can be shorter; the gas exhaust path can be formed without losing the weight balance of the rotation body 53; and manufacturing becomes easy. Further, in order to ensure a successful exhaust of the gas 57, it is also possible to enlarge a cross-sectional area of the through hole 246. In particular, as shown in FIG. 20A, with a cross-section having a longer side in a circumferential direction, the gas 57 can be successfully exhausted.

### Fifth Embodiment

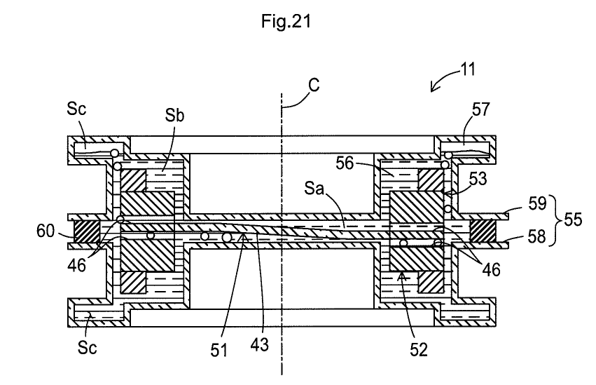

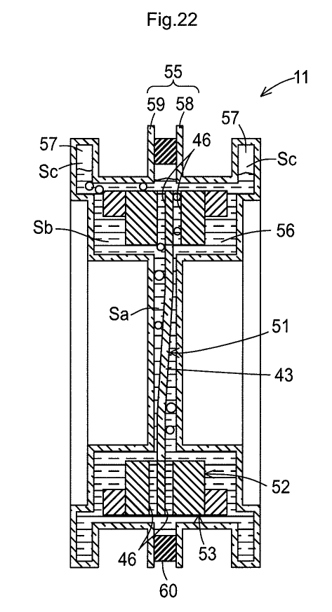

FIG. 21 is a longitudinal cross-sectional view schematically showing main portions of an image capturing portion 11 according to a fifth embodiment of the present invention. FIG. 22 is a longitudinal cross-sectional view schematically showing a posterior posture-change status of the image capturing portion 11 shown in FIG. 21. In the image capturing portion 11 of the second embodiment, as shown in FIG. 4, the optical capsule 55 is configured in a size that allows formation of predetermined gaps between the optical capsule 55 and the supporting ring 52 on the outer side in the radial direction and both the sides in the axial direction so as to form a gas retaining portion. In the image capturing device 11 of the present embodiment, however, as shown in FIG. 21, the optical capsule 55 is formed to be close to the supporting ring 52 on the outer side in the radial direction and on both the sides in the axial direction. In addition, gas retaining spaces Sc are provided to specifically retain the gas 57 at both ends of the optical capsule 55 in the axial direction. The gas retaining spaces Sc each have a large annular ring shape having portions each protruding in the axial and the radial direction.

With the optical capsule 55 being configured as described above, in a case where the rotation body 53 is rotationally driven with the axis thereof being vertical, as shown in FIG. 21, the gas 57 in the optical capsule 55 is retained in the gas retaining spaces Sc on the upper side. On the other hand, when the rotation body 53 is rotationally driven with the axis thereof being horizontal, as shown in FIG. 22, the gas 57 is retained in upper portions of both the gas retaining spaces Sc. In other word, even when the image capturing portion 11 changes a posture thereof, it is unlikely that the gas 57 enters into the concave portions 53a and 53b of the rotation body 53. Therefore, the posture detector 86 may be omitted. Further, in the rotational driving control (see FIG. 19) by the calculation processor 77, the determination on the reverse operation of the optical capsule 55 (step ST5), and the process to set the rotation speed for a reverse operation (steps ST8 to ST10) may be omitted. Alternatively, criteria to determine the reverse operation of the optical capsule 55 (step ST5) may be toughened, for example, by adding conditions such as an inclination angle after a reverse operation to be equal to or more than a certain angle, each speed at the time of a reverse operation to be equal to or faster than a certain speed, or the like. Thereby, the process to set the rotation speed for a reverse operation (steps ST8 to ST10) can be less frequently performed.

It is noted that the foregoing descriptions about specific embodiments of the present invention have been provided merely examples and are in no way to be construed as limiting of the present invention. For example, in the second and third embodiments above, the through holes 46 and 146, that pass through the supporting ring 52, are provide as the gas exhaust paths. When the difference in uneven surface of the rotation body 53 having an H-shaped cross section is small, however, a groove may be provided on the supporting ring 52 as a gas exhaust path with the bottom surface of the groove fitting along the front surface of the optical member 51. Further, all the components of the image capturing device of the present invention described in the above embodiments are not necessarily required, and may be appropriately selected as needed, within the scope of the present invention.

The image capturing device according to the present invention is suitable for generating a high-resolution image by a super-resolution processing based on a plurality of original images obtained by a pixel shift, and is capable of providing a long-term dependability, inhibiting vibration, reducing influence of device vibration on the amount of an optical shift by reducing a change in angle with respect to an optical axis of a rotation body even when the device vibrates, and stably rotating the rotation body even in a cold environment.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible, including combining features of various embodiments, without departing from the scope of the present invention.

What is claimed is:

1. An image capturing device comprising:
an image capturing element that performs photoelectric conversion on light from an object and outputs a pixel signal;
a lens unit that forms an image on the image capturing element based on light from the object;
a capsule member in which a liquid is contained;
a rotation body that is received in the capsule member and is inclined at a predetermined angle with respect to an optical axis of the lens unit; and
a rotational driving device that displaces an optical image formed on a light-receiving surface of the image capturing element and the image capturing element relative to each other by rotating the rotation body about the optical axis of the lens unit, and
wherein a heater is provided to the capsule member to heat the liquid.

2. The image capturing device according to claim 1, wherein the liquid has a higher refractive index than a refractive index of air and a lower refractive index than a refractive index of the rotation body.

3. The image capturing device according to claim 2, wherein the liquid is anti-freeze solution.

4. The image capturing device according to claim 2, wherein the liquid is water.

5. The image capturing device according to claim 1, wherein the capsule member comprises a resin.

6. The image capturing device according to claim 1, wherein the capsule member comprises a glass material.

7. The image capturing device according to claim 1, wherein the heater comprises the rotational driving device.

8. The image capturing device according to claim 7, wherein the rotational driving device comprises a first magnetizer provided to the rotation body, and a magnetic rotation driver that rotates the rotation body by applying a magnetic force in a rotation direction onto the first magnetizer.

9. The image capturing device according to claim 8, wherein the first magnetizer is provided so as to face an outer peripheral surface of the rotation body,
the magnetic rotation driver comprises a stator core that opposes the first magnetizer, and a coil that is wound around the stator core, and
a surface, which opposes the first magnetizer, of the stator core is shaped to fit along an outer surface of the capsule member.

10. The image capturing device according to claim 9, wherein a thermal conductor is provided between the stator core and the capsule member.

11. The image capturing device according to claim 10, wherein the thermal conductor comprises silicon grease.

12. The image capturing device according to claim 1, wherein the rotation body is provided with concave portions on both surfaces in the optical axis direction, and a gas exhaust path, through which a gas in each concave portion is exhausted to the outside of each concave portion.

13. The image capturing device according to claim 12, wherein the gas exhaust path is a through hole.

14. The image capturing device according to claim 13, wherein the through hole connects the two concave portions.

15. The image capturing device according to claim 12, wherein the rotational driving device comprises a calculation processor that sets a rotation speed of the rotation body, and the calculation processor sets the rotation speed of the rotation body at a predetermined startup speed for a predetermined time period upon starting up rotation of the rotation body.

16. The image capturing device according to claim 15, further comprising:
a posture detector that detects a posture of the capsule member, and
wherein when the calculation possessor determines, based on a detection result of the posture detector, that the capsule member has reversed its posture so as to move the gas to the opposite side, in the optical axis direction, the calculation processor sets the rotation speed of the rotation body at a predetermined speed for a reverse operation for a predetermined time period.

17. An image capturing device comprising:
an image capturing element that performs photoelectric conversion on light from an object and outputs a pixel signal;
a lens unit that forms an image on the image capturing element based on light from the object;
a capsule containing a liquid;
a rotation body that is received in the capsule and is inclined at a predetermined angle with respect to an optical axis of the lens unit; and
a rotational driver that displaces an optical image formed on a light receiving surface of the image capturing element and the image capturing element relative to each other by rotating the rotation body about the optical axis of the lens unit, and
the capsule additionally containing gas, the rotation body configured with concave portions on each surface in a direction of the optical axis, the rotation body further including at least one gas exhaust path by which gas present in the concave portions is exhausted outside of each of the concave portions.

18. The image capturing device according to claim 17, the gas exhaust path comprising a plurality of radially extending apertures extending along opposite surfaces of the rotation body.

19. The image capturing device according to claim 17, the rotational driver comprises a controller that sets a rotational speed of the rotation body at a first speed for a predetermined period of time upon startup, the first speed being determined so as to exhaust gas through the gas exhaust path, the controller setting a second speed, lower than the first speed, after the predetermined period of time.

20. The image capturing device according to claim 1, further comprising a temperature sensor, the rotation driving device driving the rotation body in a mode in which the temperature of the liquid within the capsule is increased, in response to an output from the temperature sensor indicating that the temperature of the liquid is below a predetermined level.

21. The image capturing device according to claim 9, further comprising:
a calculation processor that sets a rotation speed of the rotation body and an electric current to be provided through the coil;
a three-phase driver that controls the electric current to be provided through the coil based on the electric current set by the calculation processor and an electric current signal provided through the coil;
a dummy signal generator that generates a dummy signal of the electric current signal to be provided through the coil based on the rotation speed set by the calculation processor;
a switch that inputs, to the three-phase driver, either one of the electric current signal provided through the coil or the dummy signal; and
a viscosity increase detector that detects an increase in viscosity of the liquid,
wherein the calculation processor controls the switch so as to input, to the three-phase driver, the electric current signal provided through the coil in a condition when viscosity does not increase above a predetermined amount, and to input the dummy signal to the three-phase driver when a predetermined increase in viscosity of the liquid is detected by the viscosity increase detector.

22. The image capturing device according to claim 9, wherein
the rotational driving device further comprising:
a first position controller that is provided to an outer peripheral surface of the capsule member and controls a position of the rotation body in the radial direction by applying a radial-direction magnetic force to the first magnetizer;
a second magnetizer that is provided to the rotation body and faces one end surface of the rotation body in an axial direction; and
a second position controller that is provided to one end surface of the capsule member in the axial direction and controls the position of the rotation body in the axial direction by applying an axial-direction magnetic force to the second magnetizer,
wherein the heater comprises at least one of the first position controller and the second position controller.

23. The image capturing device according to claim 22, wherein the first position controller comprises a first magnetic body that opposes the first magnetizer, and a coil that is wound around the first magnetic body,
the second position controller comprises a second magnetic body that opposes the second magnetizer, and a coil that is wound around the second magnetic body, and
at least either one of a surface of the first magnetic body which opposes the first magnetizer and a surface of the second magnetic body which opposes the second magnetizer is shaped to correspond to a shape of the outer surface of the capsule member.

24. The image capturing device according to claim 12, wherein the capsule member forms a sealed space which includes a central space and a radially outer annular space, the central space having a circular plate shape, being situated at the center of the capsule member, and storing the rotation body, and the outer annular space extending to the outer peripheral side of the central space and having an width, in the optical axis direction greater than a width of the central space, in the optical axis direction, and
the outer annular space acts as a gas retainer that retains the gas.
